(19) United States
(12) Patent Application Publication
(10) Pub. No.: US 2026/0235855 A1
(43) Pub. Date: Aug. 13, 2026

(54) ZOOM LENS AND IMAGE PICKUP APPARATUS

(71) Applicant: CANON KABUSHIKI KAISHA, Tokyo (JP)

(72) Inventor: Kazufumi GOTO, Tochigi (JP)

(21) Appl. No.: 19/530,442

(22) Filed: Feb. 5, 2026

(30) Foreign Application Priority Data
Feb. 12, 2025 (JP) 2025-020608

(51) Int. Cl. G02B 13/00; G02B 15/14

(52) U.S. Cl. CPC G02B 13/009; G02B 13/008; G02B 15/1461

(57) ABSTRACT

A zoom lens may include, in order from an object side to an image side, a first lens unit with positive refractive power that does not move for magnification variation, a movable lens unit including at least two lens units that move for magnification variation, and a rear lens unit with positive refractive power that does not move for magnification variation. Each distance between adjacent lens units may change for magnification variation. Predetermined inequalities may be satisfied.

### BACKGROUND

### Field of the Technology

The present disclosure relates to a zoom lens and an image pickup apparatus.

### Description of the Related Art

Positive lead type zoom lenses have conventionally been known, which include a first lens unit with positive refractive power disposed closest to an object.

### SUMMARY

A zoom lens according to one aspect of the present disclosure may include, in order from an object side to an image side, a first lens unit with positive refractive power that does not move for magnification variation, a movable lens unit including at least two lens units that move for magnification variation, and a rear lens unit with positive refractive power that does not move for magnification variation. Each distance between adjacent lens units may change for magnification variation. The following inequalities may be satisfied:

$$0.2 < ( fl + bok 1 ) / fl < 0 \text{.70}$$

$$3. 50 < f t / fl < 8 \text{.00}$$

$$3. 00 < f l / fw < 20 \text{.00}$$

$$35. 0 < vdLN < 65.$$

$$0.56 < θ CtLN - 0.00 \; 46 \times vdLN < 0.6$$

where f1 is a focal length of the first lens unit, bok1 is a distance on an optical axis from a lens surface closest to an image plane of the first lens unit in an in-focus state at infinity to an image-side principal point of the first lens unit, ft is a focal length of the zoom lens at a telephoto end, fw is a focal length of the zoom lens at a wide-angle end, vdLN is an Abbe number for d-line of a negative lens included in the first lens unit, and θCtLN is a partial dispersion ratio for C-line and t-line of the negative lens. An image pickup apparatus having the above zoom lens also constitutes another aspect of the present disclosure.

Features of the present disclosure will become apparent from the following description of embodiments with reference to the attached drawings. The following description of embodiments is described by way of example.

### BRIEF DESCRIPTION OF THE DRAWINGS

FIG. 1 is a sectional view of a zoom lens according to Example 1 in an in-focus state (on an object) at infinity at a wide-angle end.

FIGS. 2A, 2B, and 2C are aberration diagrams of the zoom lens according to Example 1 in the in-focus state at infinity at the wide-angle end, an intermediate zoom position, and a telephoto end, respectively.

FIG. 3 is a sectional view of a zoom lens according to Example 2 in an in-focus state at infinity at a wide-angle end.

FIGS. 4A, 4B, and 4C are aberration diagrams of the zoom lens according to Example 2 in the in-focus state at infinity at the wide-angle end, an intermediate zoom position, and a telephoto end, respectively.

FIG. 5 is a sectional view of a zoom lens according to Example 3 in an in-focus state at infinity at a wide-angle end.

FIGS. 6A, 6B, and 6C are aberration diagrams of the zoom lens according to Example 3 in the in-focus state at infinity at the wide-angle end, an intermediate zoom position, and a telephoto end, respectively.

FIG. 7 is a sectional view of a zoom lens according to Example 4 in an in-focus state at infinity at a wide-angle end.

FIGS. 8A, 8B, and 8C are aberration diagrams of the zoom lens according to Example 4 in the in-focus state at infinity at the wide-angle end, an intermediate zoom position, and a telephoto end, respectively.

FIG. 9 is a sectional view of a zoom lens according to Example 5 in an in-focus state at infinity at a wide-angle end.

FIGS. 10A, 10B, and 10C are aberration diagrams of the zoom lens according to Example 5 in the in-focus state at infinity at the wide-angle end, an intermediate zoom position, and a telephoto end, respectively.

FIG. 11 is a sectional view of a zoom lens according to Example 6 in an in-focus state at infinity at a wide-angle end.

FIGS. 12A, 12B, and 12C are aberration diagrams of the zoom lens according to Example 6 in the in-focus state at infinity at the wide-angle end, an intermediate zoom position, and a telephoto end, respectively.

FIG. 13 is a sectional view of a zoom lens according to Example 7 in an in-focus state at infinity at a wide-angle end.

FIGS. 14A, 14B, and 14C are aberration diagrams of the zoom lens according to Example 7 in the in-focus state at infinity at the wide-angle end, an intermediate zoom position, and a telephoto end, respectively.

FIG. 15 is a schematic diagram of the main parts of an image pickup apparatus having a zoom lens according to each example.

### DESCRIPTION OF THE EMBODIMENTS

Referring now to the accompanying drawings, a detailed description will be given of examples according to the present disclosure.

First, the characteristics of a zoom lens according to each example will be described in accordance with each inequality. The zoom lens according to each example properly sets a paraxial amount of a first lens unit, and a glass material of the first lens unit. This achieves high optical performance in a wavelength range from visible light to near infrared (NIR) light (near infrared light with wavelengths of approximately 750 nm to 1000 nm), a high zoom ratio, and a reduced size and weight. More specifically, each example can provide a zoom lens that achieves high optical performance in the wavelength range from visible light to near infrared light, a high zoom ratio, and a reduced size and weight, with a magnification varying ratio of approximately 22 to 28 times.

The zoom lens according to each example includes, in order from the object side to the image side, a first lens unit with positive refractive power that does not move for magnification variation, a movable lens unit consisting of at least two lens units that move for magnification variation, and a rear lens unit with positive refractive power. In the zoom lens according to each example, each distance between adjacent lens units changes for magnification variation. In each example, at least one of the following inequalities (1) to (12) may be satisfied.

Let f1 be a focal length of the first lens unit, bok1 be a distance on the optical axis from the lens surface closest to the image plane of the first lens unit to an image-side principal point of the first lens unit in the in-focus state at infinity, ft be a focal length of the zoom lens at a telephoto end, and fw be a focal length of the zoom lens at a wide-angle end. Then, at least one of the following inequalities (1) to (3) may be satisfied:

$$0.2 < ( fl + bok 1 ) / fl < 0 \text{.70} \qquad ( 1 )$$

$$3. 47 < f t / fl < 8. \qquad ( 2 )$$

$$3. 00 < fl / fw < 20.00 \qquad ( 3 )$$

Let vdLN be an Abbe number for the d-line of a negative lens LN included in the first lens unit, and OCtLN be a partial dispersion ratio for the C-line and t-line of the negative lens LN included in the first lens unit. Then, at least one of the following inequalities (4) and (5) may be satisfied:

$$35. < vdLN < 65. \qquad ( 4 )$$

$$0.56 < θ CtLN - 0.00 \; 46 \times vdLN < 0.6 \qquad ( 5 )$$

Here, nF, nC, nd, and nt are refractive indices of the materials for the F-line (486.1 nm), C-line (656.3 nm), d-line (wavelength 587.6 nm), and t-line (1014.0 nm). The Abbe number νd and partial dispersion ratio θCt are expressed as follows:

$$v d = ( n d - 1 ) / ( n F - nC )$$

$$θ Ct = ( n C - n t ) / ( n F - n C )$$

The Abbe number νd for the d-line and the partial dispersion ratio θCt for the C-line and t-line will also be simply referred to as the Abbe number νd and the partial dispersion ratio θCt.

The first lens unit may include a plurality of negative lenses. Next, the technical significance of inequalities (1) to (5) will be discussed.

Inequality (1) defines a proper relationship between the focal length of the first lens unit and the image-side principal point position. Satisfying inequality (1) achieves high optical performance in the wavelength range from visible light to NIR light, a high zoom ratio, and a reduced size and weight.

In a case where (f1+bok1)/f1 becomes higher than the upper limit of inequality (1), the image-side principal point position of the first lens unit will be located excessively toward the image plane, the absolute value of the lateral magnification of the second lens unit at the wide-angle end will become excessively small, and the moving amount of the second lens unit will increase, making the size of the zoom lens excessively increase. Alternatively, the focal length of the first lens unit will excessively reduce, making it difficult to keep a variety of aberrations within the permissible range at the telephoto end.

In a case where (f1+bok1)/f1 becomes lower than the lower limit of inequality (1), the image-side principal point position of the first lens unit will be located too far toward the object, and the entrance pupil position at the wide-angle end will be located too far toward the image plane, making the first lens unit excessively large. Alternatively, the focal length of the first lens unit will be excessively long, the absolute value of the lateral magnification of the second lens unit at the wide-angle end will be excessively small, and the moving amount of the second lens unit will be large, making the size of the zoom lens excessively large.

Inequality (2) defines a proper ratio between the focal length of the first lens unit and the focal length of the zoom lens at the telephoto end. Satisfying inequality (2) achieves high optical performance in the wavelength range from visible light to NIR light, a high zoom ratio, and a reduced size and weight.

In a case where ft/f1 becomes higher than the upper limit of inequality (2), the focal length of the first lens unit becomes relatively too short, which increases the magnification of aberrations generated in the first lens unit, making it difficult to suppress a variety of aberrations at the telephoto end. In a case where ft/f1 becomes lower than the lower limit of inequality (2), the focal length of the first lens unit becomes relatively too long, which increases the extension amount required for focusing and results in a larger lens.

Inequality (3) defines a proper ratio between the focal length of the first lens unit and the focal length of the zoom lens at the wide-angle end. Satisfying inequality (3) achieves high optical performance in the wavelength range from visible light to near-infrared light, a high zoom ratio, and a reduced size and weight. In a case where f1/fw becomes higher than the upper limit of inequality (3), the focal length of the first lens unit becomes excessively long, which increases the diameter of the first lens unit and makes it difficult to achieve a reduced size and weight. In a case where f1/fw becomes lower than the lower limit of inequality (3), the focal length of the first lens unit will be excessively short, making aberration correction difficult.

Inequalities (4) and (5) define a proper material of the negative lens LN included in the first lens unit. Satisfying inequalities (4) and (5) achieves high optical performance in the wavelength range from visible light to NIR light, a high zoom ratio, and a reduced size and weight.

In a zoom lens in which the first lens unit with positive refractive power is fixed during magnification variation, as in each example, the on-axis rays pass through the first lens unit at the highest position at the telephoto end. The on-axis rays pass through a position significantly higher than that of the lens unit closer to the image plane than the first lens unit. Therefore, it is important to correct chromatic aberration within the first lens unit in the wavelength range from visible light to NIR light.

In a case where νdLN becomes higher than the upper limit of inequality (4), a material with an excessively small θCt will be selected for the negative lens LN, making it difficult to correct chromatic aberrations in the wavelength range from visible light to NIR light at the telephoto end. In a case where νdLN becomes lower than the lower limit of inequality (4), a material with an excessively low dispersion will be selected for the negative lens LN, reducing the difference in Abbe number with the positive lens and making it difficult to correct various aberrations at the telephoto end. In a case where inequality (5) is not satisfied, it will be difficult to correct chromatic aberrations in the wavelength range from visible light to NIR light at the telephoto end.

Glass materials that satisfy inequalities (4) and (5) include, for example, S-BSM81, S-LAL7Q, and S-LAL54Q manufactured by Ohara Inc.

Let θCt1Pav be an average value of partial dispersion ratios for the C-line and t-line of all positive lenses included in the first lens unit, and θCt1Nav be an average value of partial dispersion ratios for the C-line and t-line of all negative lenses included in the first lens unit. Then, the following inequality (6) may be satisfied:

$$- 0.040 < θ Ct 1 Pav - θ Ct 1 Nav < 0.06 \qquad ( 6 )$$

Satisfying inequality (6) achieves high optical performance across the wavelength range from visible to near-infrared light, a high zoom ratio, and a reduced size and weight. In a case where θCt1Pav−θCt1Nav becomes higher than the upper limit of inequality (6), a material for the positive lens with an excessively high partial dispersion ratio or a material for the negative lens with an excessively low partial dispersion ratio (undercorrection) will be selected. As a result, secondary chromatic aberration at the telephoto end becomes excessively large. In a case where θCt1Pav−θCt1Nav becomes lower than the lower limit of inequality (6), either an excessively low partial dispersion ratio for the positive lens material or an excessively high partial dispersion ratio for the negative lens material will be selected. As a result, secondary chromatic aberration at the telephoto end will be excessively large (overcorrected).

Let νd1Pav be an average value of an Abbe numbers for the d-line of all positive lenses included in the first lens unit, and νd1Nav be an average value of Abbe numbers for the d-line of all negative lenses included in the first lens unit. Then, the following inequality (7) may be satisfied:

$$10. < vd 1 Pav - vd 1 Nav < 60. \qquad ( 7 )$$

Satisfying inequality (7) achieves high optical performance across the wavelength range from visible to near-infrared light, a high zoom ratio, and a reduced size and weight. In a case where νd1Pav-νd1Nav becomes higher than the upper limit of inequality (7), materials with excessively different partial dispersion ratios θCt will be selected for the positive and negative lenses in the first lens unit, resulting in excessively large secondary chromatic aberrations at the telephoto end. In a case where νd1Pav−νd1Nav becomes lower than the lower limit of inequality (7), a chromatic aberration at the telephoto end will be excessively large. Alternatively, the refractive power of the lenses included in the first lens unit will be excessively strong, resulting in excessively large aberrations (including chromatic aberrations) at the telephoto end.

Among the lens units in the movable lens unit, the lens unit with negative refractive power that is located closest to the object is designated the first negative lens unit. In addition, let fN1 be a focal length of the first negative lens unit. The following inequality (8) may be satisfied:

$$- 10.00 < f l / fN 1 < - 4. \qquad ( 8 )$$

Satisfying inequality (8) achieves high optical performance in the wavelength range from visible light to NIR light, a high zoom ratio, and a reduced size and weight. In a case where f1/fN1 becomes higher than the upper limit of inequality (8), a focal length of the first lens unit will be excessively short and aberrations (including a chromatic aberration) at the telephoto end will be excessively large. In a case where f1/fN1 becomes lower than the lower limit of inequality (8), the lens diameter of the first lens unit is excessively large, and it becomes difficult to reduce the size and weight.

Let βN1w be a lateral magnification of the first negative lens unit at the wide-angle end, the following inequality (9) may be satisfied:

$$- 0.80 < β N 1 w < 0.00 \qquad ( 9 )$$

Satisfying inequality (9) achieves high optical performance across the wavelength range from visible light to NIR light, a high zoom ratio, and a reduced size and weight. In a case where βN1w becomes higher than the upper limit of inequality (9), a moving amount of the second lens unit is excessively large, the size of the zoom lens excessively increases, and it becomes difficult to reduce the size and weight. In a case where βN1w becomes lower than the lower limit of inequality (9), the focal length at the wide-angle end becomes telephoto, and thus, to achieve a high zoom ratio, the focal length at the telephoto end may be excessively long, resulting in an increased size of the first lens unit and making it difficult to reduce the size and weight.

In each example, the first lens unit consists of a plurality of subunits, in which each distance between adjacent subunits changes during focusing. The plurality of subunits include, in order from the object side to the image side, a first subunit that does not move for focusing, and a second subunit with positive refractive power that moves for focusing. Let f12 be a focal length of the second subunit. Then, the following inequality (10) may be satisfied:

$$1. < f 1 / f 12 < 3. \qquad ( 10 )$$

Satisfying inequality (10) achieves high optical performance across the wavelength range from visible light to near-infrared light, a high zoom ratio, and a reduced size and weight. In a case where f1/f12 becomes higher than the upper limit of inequality (10), refractive power of the second subunit becomes excessively strong and fluctuations in aberrations during focusing become excessively large. In a case where f1/f12 becomes lower than the lower limit of inequality (10), the refractive power of the second subunit becomes excessively weak, a moving amount of the second subunit during focusing becomes large, and the first lens unit becomes excessively large.

Let L1 be a distance on the optical axis from the lens surface closest to the object in the first lens unit to the lens surface closest to the image plane in the first lens unit in the in-focus state at infinity. Then, the following inequality (11) may be satisfied:

$$1. < f 1 / L 1 < 2.50 \qquad ( 11 )$$

Satisfying inequality (11) achieves high optical performance in the wavelength range from visible light to NIR light, a high zoom ratio, and a reduced size and weight. In a case where f1/L1 becomes higher than the upper limit of inequality (11), the first lens unit becomes excessively thin, the number of usable lenses reduces, and it becomes difficult to properly correct a variety of aberrations. In a case where f1/L1 becomes lower than the lower limit of inequality (11), the first lens unit becomes excessively thick, the lens diameter of the first lens unit increases, and it becomes difficult to reduce the size and weight. Alternatively, the focal length of the first lens unit becomes excessively short, and it becomes difficult to properly correct a variety of aberrations.

In each example, the following inequality (12) may be satisfied:

$$- 1. < bok 1 / L 1 < - 0.4 \qquad ( 12 )$$

Satisfying inequality (12) achieves high optical performance in the wavelength range from visible light to NIR light, a high zoom ratio, and a reduced size and weight.

In a case where bok1/L1 becomes higher than the upper limit of inequality (12), the image-side principal point position of the first lens unit will be located excessively close to the image plane, the absolute value of the lateral magnification of the second lens unit at the wide-angle end will be too small, the moving amount of the second lens unit will be large, and the zoom lens becomes excessively large. Alternatively, the focal length of the first lens unit will be too short, making it difficult to correct a variety of aberrations at the telephoto end. In a case where bok1/L1 becomes lower than the lower limit of inequality (12), the image-side principal point position of the first lens unit will be located excessively close to the object, the entrance pupil position at the wide-angle end will be located excessively close to the image plane, and the zoom lens becomes excessively large. In a case where the focal length of the first lens unit is too long, the absolute value of the lateral magnification of the second lens unit at the wide-angle end will be too small, the moving amount of the second lens unit will be large, and the zoom lens becomes excessively large.

In each example, inequalities (1) to (12) may be replaced with the following inequalities (1a) to (12a), respectively:

$$0.3 < ( f 1 + bok 1 ) / f 1 < 0.68 \qquad ( 1 a )$$

$$3.49 < f t / f 1 < 7. \qquad ( 2 a )$$

$$3.5 < f 1 / fw < 10. \qquad ( 3 a )$$

$$45. < vdLN < 64. \qquad ( 4 a )$$

$$0.563 < θ CtLN - 0.0046 \times vdLN < 0.59 \qquad ( 5 a )$$

$$- 0.02 < θ Ct 1 Pav - θ Ct 1 Nav < 0.04 \qquad ( 6 a )$$

$$20 < vd 1 Pav - vd 1 Nav < 50 \qquad ( 7 a )$$

$$- 8.5 < f 1 / fN 1 < - 5. \qquad ( 8 a )$$

$$- 0.6 < β N 1 w < - 0.1 \qquad ( 9 a )$$

$$1.1 < f 1 / f 12 < 2 \text{.50} \qquad ( 10 a )$$

$$1.2 < f 1 / L 1 < 2 \text{.00} \qquad ( 11 a )$$

$$- 0.9 < bok 1 / L 1 < - 0.5 \qquad ( 12 a )$$

In each example, inequalities (1) to (12) may be replaced with the following inequalities (1b) to (12b), respectively:

$$0.4 < ( f 1 + bok 1 ) / f 1 < 0.65 \qquad ( 1 b )$$

$$3.5 < f t / f 1 < 5.98 \qquad ( 2 b )$$

$$4. < f 1 / fw < 8. \qquad ( 3 b )$$

$$50. < vdLN < 62. \qquad ( 4 b )$$

$$0.57 < θ CtLN - 0.0046 \times vdLN < 0.589 \qquad ( 5 b )$$

$$- 0.01 < θ Ct 1 Pav - θ Ct 1 Nav < 0.03 \qquad ( 6 b )$$

$$25. < vd 1 Pav - vd 1 Nav < 40. \qquad ( 7 b )$$

$$- 8.2 < f 1 / fN 1 < - 6. \qquad ( 8 b )$$

$$- 0.4 < β N 1 w < - 0.2 \qquad ( 9 b )$$

$$1.2 < f 1 / f 12 < 2.2 \qquad ( 10 b )$$

$$1.5 < f 1 / L 1 < 1.8 \qquad ( 11 b )$$

$$- 0.85 < bok 1 / L 1 < - 0.52 \qquad ( 12 b )$$

The image pickup apparatus according to each example includes the zoom lens according to each example and an image sensor with a predetermined effective imaging range that receives an image formed by the zoom lens.

The specific configurations of the zoom lenses according to numerical examples 1 to 7 corresponding to Examples 1 to 7 will be described below:

### Example 1

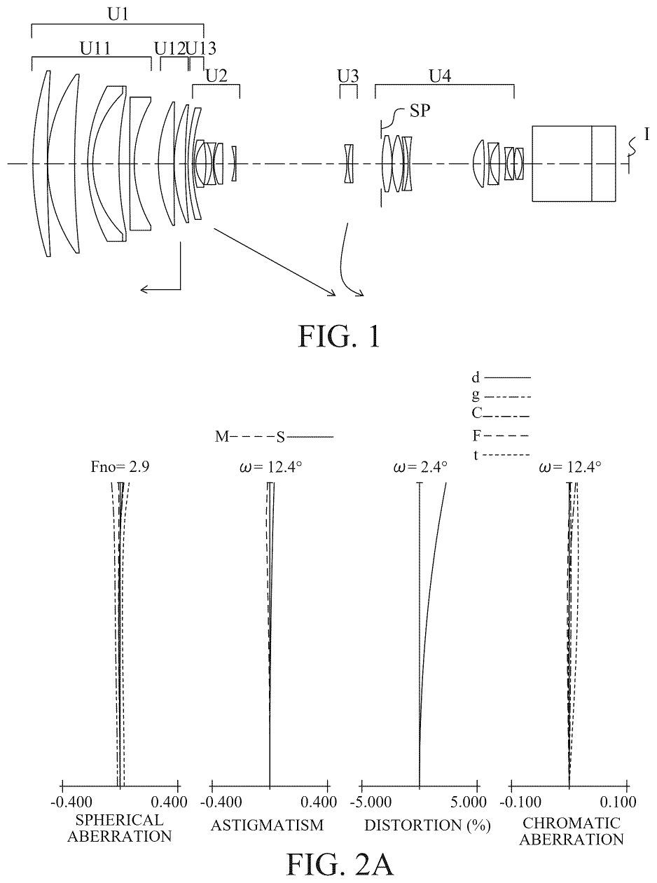

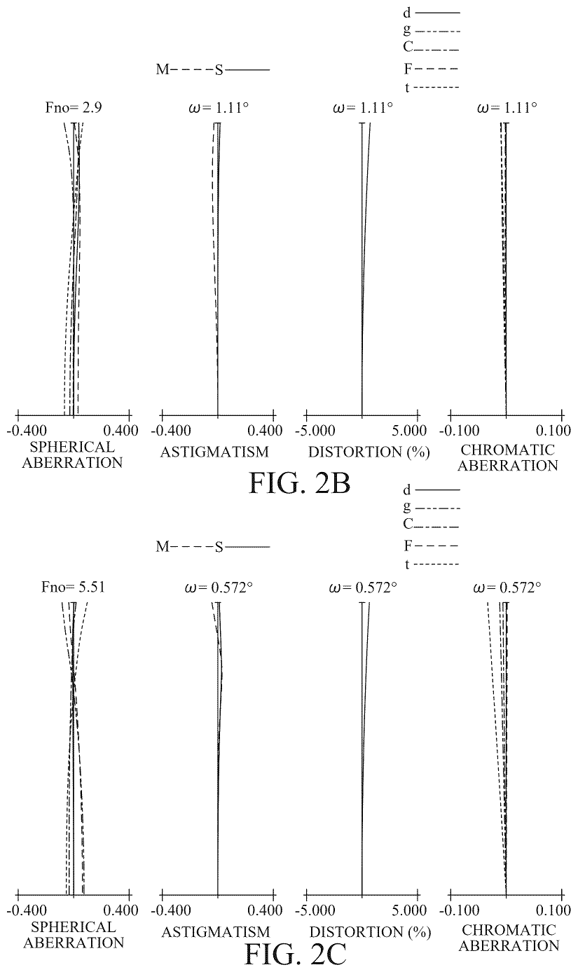

FIG. 1 is a sectional view of a zoom lens in an in-focus state at infinity at a wide-angle end according to Example 1 (numerical example 1) of this disclosure. FIGS. 2A, 2B, and 2C are longitudinal aberration diagrams of the zoom lens according to this example in the in-focus state at infinity at the wide-angle end, a focal length of 282.8 mm (middle zoom position), and at a telephoto end, respectively. The focal length has a value in units of mm. This is similarly applicable to the following examples.

The zoom lens according to this example includes, in order from the object side to the image side, a first lens unit U1, a second lens unit U2, a third lens unit U3, and a fourth lens unit U4. The first lens unit U1 is a lens unit with positive refractive power for focusing that does not move for magnification variation. The second lens unit U2 is a lens unit with negative refractive power for magnification variation that moves to the image side during magnification variation from the wide-angle end to the telephoto end. The third lens unit U3 is a lens unit with negative refractive power that moves non-linearly on the optical axis in conjunction with the movement of the second lens unit U2 and corrects image plane fluctuations associated with magnification variation. The fourth lens unit U4 is a lens unit with positive refractive power (rear lens unit) that performs an imaging action and does not move for magnification variation.

The first lens unit includes a plurality of subunits in which each distance between adjacent subunits changes during focusing. The plurality of subunits consists of, in order from the object side to the image side, a first subunit U11 that does not move for focusing, a second subunit U12 with positive refractive power that moves for focusing, and a third subunit U13 with negative refractive power that is adjacent to the second subunit on the image side.

In this example, the second lens unit U2 and the third lens unit U3 constitute a magnification varying system (movable lens unit). SP represents an aperture stop, which is included in the fourth lens unit U4 and is located closest to the object in the fourth lens unit U4. I represents an image plane. In a case where the zoom lens is used as the imaging optical system of a broadcasting television camera, video camera, or digital still camera, the image plane I corresponds to the imaging surface of an image sensor (photoelectric conversion element) that receives and photoelectrically converts an image formed by the zoom lens. In a case where the zoom lens is used as the imaging optical system of a film camera, the image plane I corresponds to the film surface to which the image formed by the zoom lens is exposed.

In the longitudinal aberration diagram, a solid line, an alternate long and two short dashes line, an alternate long and short dash line, a long broken line, and a short broken line in the spherical aberration diagram represent the d-line, g-line, C-line, F-line, and t-line, respectively. The wavelength of the d-line is 587.6 nm, the wavelength of the g-line is 435.8 nm, the wavelength of the C-line is 656.3 nm, the wavelength of the F-line is 486.1 nm, and the wavelength of the t-line is 1014.0 nm. The broken and solid lines in the astigmatism represent the meridional and sagittal image planes, respectively. The alternate long and two short dashes line, alternate long and short dash line, long broken line, and short broken line in the lateral chromatic aberration represent the g-line, C-line, F-line, and t-line, respectively. ω represents a half angle of view, and Fno represents an F-number. In the longitudinal aberration diagram, the spherical aberration is illustrated on a scale of 0.4 mm, the astigmatism is illustrated on a scale of 0.4 mm, the distortion is illustrated on a scale of 5%, and the lateral chromatic aberration is illustrated on a scale of 0.1 mm. In the following examples, the wide-angle end and telephoto end refer to the zoom positions when the second lens unit U2 for magnification variation is located at both ends of the movable range in the optical axis direction on the mechanism.

The first lens unit U1 corresponds to the first to fifteenth surfaces. The second lens unit U2 corresponds to the sixteenth to twenty-fourth surfaces. The third lens unit U3 corresponds to the twenty-fifth to twenty-seventh surfaces. The fourth lens unit U4 corresponds to the twenty-ninth to forty-sixth surfaces.

Table 1 summarizes the values for inequalities for the zoom lens according to this example. The zoom lens according to this example satisfies inequalities (1) to (12). By properly setting the paraxial amount of the first lens unit and the glass material of the first lens unit, this example can achieve high optical performance in the wavelength range from visible light to NIR light, a high zoom ratio, and a reduced size and weight.

### Example 2

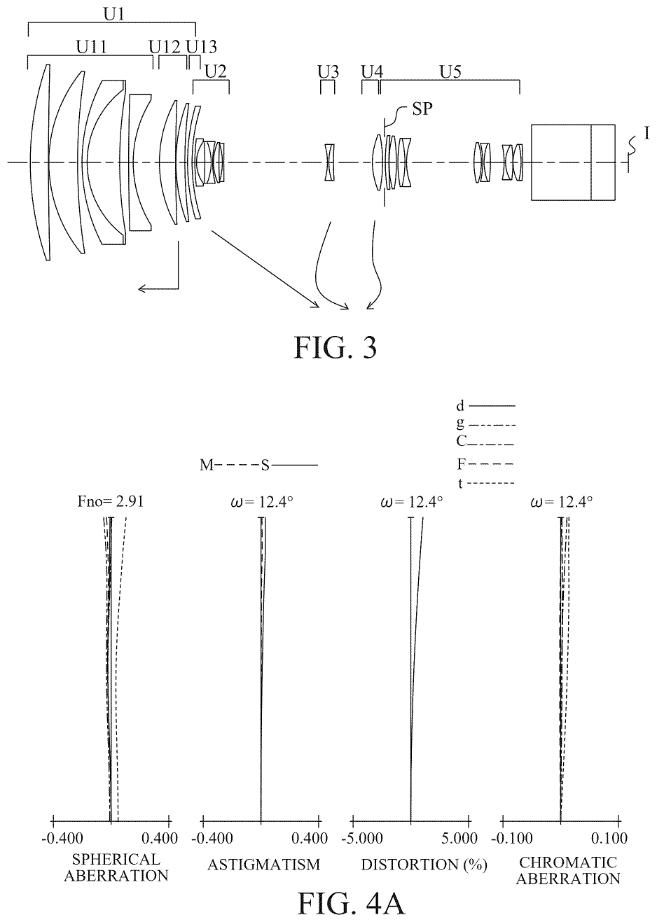

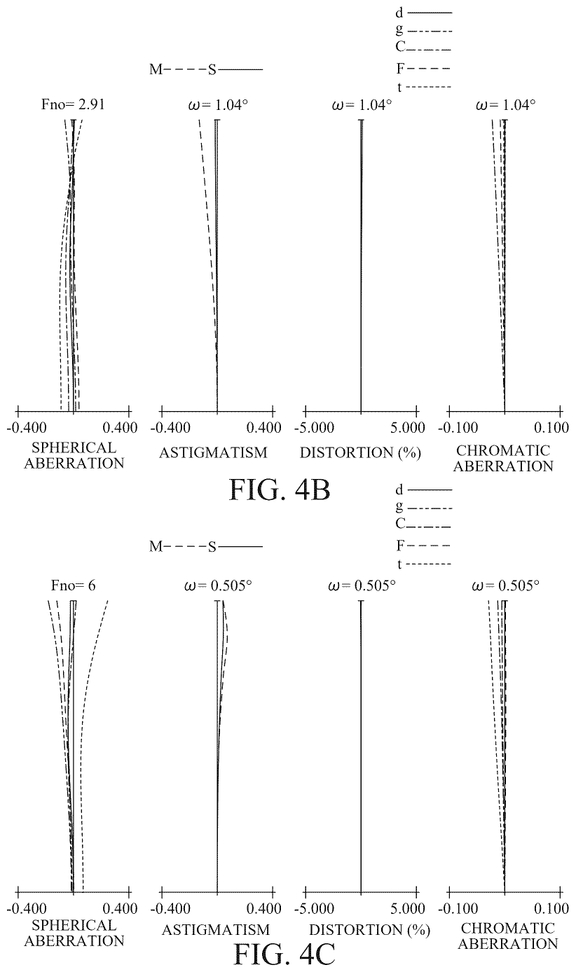

FIG. 3 is a sectional view of a zoom lens in an in-focus state at infinity at a wide-angle end according to Example 2 (numerical example 2) of this disclosure. FIGS. 4A, 4B, and 4C are longitudinal aberration diagrams of the zoom lens according to this example in the in-focus state at infinity at the wide-angle end, a focal length of 302.2 mm (middle zoom position), and a telephoto end, respectively.

The zoom lens according to this example includes, in order from the object side to the image side, a first lens unit U1, a second lens unit U2, a third lens unit U3, a fourth lens unit U4, and a fifth lens unit U5. The first lens unit U1 is a lens unit for focusing with positive refractive power that does not move for magnification variation. The second lens unit U2 is a lens unit for magnification variation with negative refractive power that moves toward the image side for magnification variation from the wide-angle end to the telephoto end. The third lens unit U3 is a lens unit with negative refractive power that moves for magnification variation from the wide-angle end to the telephoto end. The fourth lens unit U4 is a lens unit with positive refractive power that moves non-linearly on the optical axis in conjunction with the movement of the second lens unit U2 and the third lens unit U3, and corrects image plane fluctuations associated with magnification variation. The fifth lens unit U5 is a lens unit (rear lens unit) with positive refractive power that performs an imaging function and does not move for magnification variation.

The first lens unit consists of a plurality of subunits in which each distance between adjacent subunits changes during focusing. The plurality of subunits consist of, in order from the object side to the image side, a first subunit U11 that does not move for focusing, a second subunit U12 with positive refractive power that moves for focusing, and a third subunit U13 with negative refractive power that is adjacent to the second subunit on the image side.

In this example, the second lens unit U2, third lens unit U3, and fourth lens unit U4 form a magnification varying system (movable lens unit). SP is an aperture stop, disposed closer to the object than the fifth lens unit U5. I represents an image plane. In a case where the zoom lens is used as the imaging optical system of a broadcasting television camera, video camera, or digital still camera, the image plane I corresponds to the imaging surface of an image sensor (photoelectric conversion element) that receives and photoelectrically converts an image formed by the zoom lens. In a case where the zoom lens is used as the imaging optical system of a film camera, the image plane I corresponds to the film surface to which the image formed by the zoom lens is exposed.

The first lens unit U1 corresponds to the first to fifteenth surfaces. The second lens unit U2 corresponds to the sixteenth to twenty-fourth surfaces. The third lens unit U3 corresponds to the twenty-fifth to twenty-seventh surfaces. The fourth lens unit U4 corresponds to the twenty-eighth to twenty-ninth surfaces. The fifth lens unit U5 corresponds to thirty-first to forty-eighth surfaces.

Table 1 summarizes the values for inequalities for the zoom lens according to this example. The zoom lens according to this example satisfies inequalities (1) to (12). By properly setting the paraxial amount of the first lens unit and the glass material of the first lens unit, this example can achieve high optical performance in the wavelength range from visible light to NIR light, a high zoom ratio, and a reduced size and weight.

### Example 3

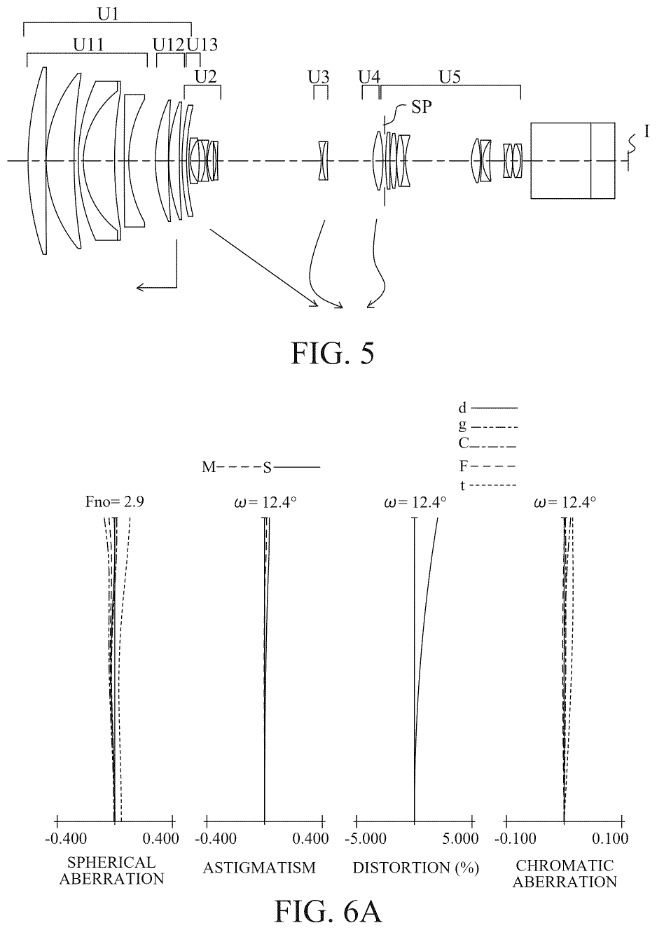

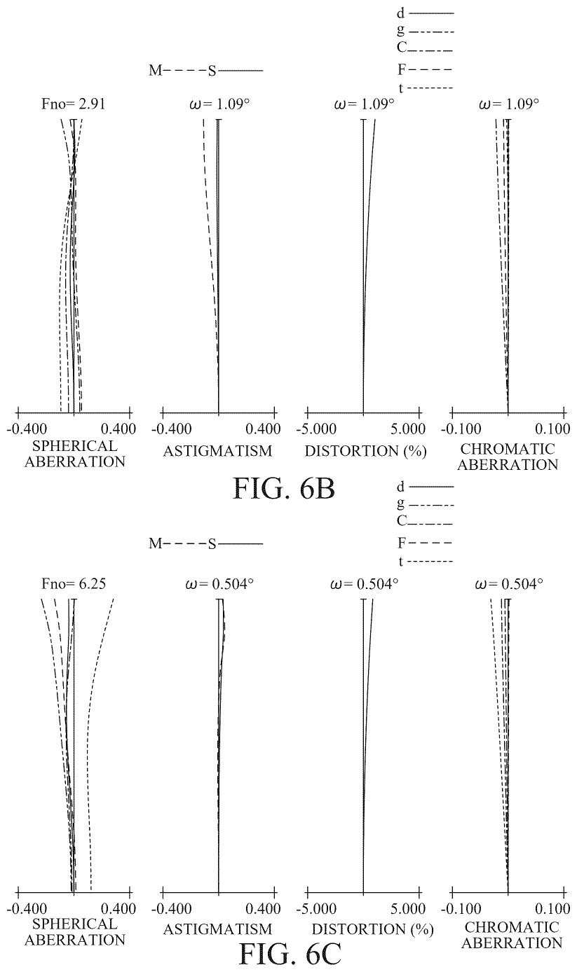

FIG. 5 is a sectional view of a zoom lens in an in-focus state at infinity at a wide-angle end according to Example 3 (numerical example 3) of this disclosure. FIGS. 6A, 6B, and 6C are longitudinal aberration diagrams of the zoom lens according to this example in the in-focus state at infinity at the wide-angle end, a focal length of 290.2 mm (middle zoom position), and a telephoto end, respectively.

The zoom lens according to this example includes, in order from the object side to the image side, a first lens unit U1, a second lens unit U2, a third lens unit U3, a fourth lens unit U4, and a fifth lens unit U5. The first lens unit U1 is a lens unit for focusing with positive refractive power that does not move for magnification variation. The second lens unit U2 is a lens unit for magnification variation with negative refractive power that moves toward the image side for magnification variation from the wide-angle end to the telephoto end. The third lens unit U3 is a lens unit with negative refractive power that moves during magnification variation from the wide-angle end to the telephoto end. The fourth lens unit U4 is a lens unit with positive refractive power that moves non-linearly on the optical axis in conjunction with the movement of the second lens unit U2 and the third lens unit U3, and corrects image plane fluctuations associated with magnification variation. The fifth lens unit U5 is a lens unit (rear lens unit) with positive refractive power that performs an imaging function and does not move for magnification variation.

The first lens unit consists of a plurality of subunits in which each distance between adjacent subunits changes during focusing. The plurality of subunits consist of, in order from the object side to the image side, a first subunit U11 that does not move for focusing, a second subunit U12 with positive refractive power that moves for focusing, and a third subunit U13 with negative refractive power that is adjacent to the second subunit on the image side.

In this example, the second lens unit U2, third lens unit U3, and fourth lens unit U4 form a magnification varying system (movable lens unit). SP represents an aperture stop, disposed closer to the object than the fifth lens unit U5. I represents an image plane. In a case where the zoom lens is used as the imaging optical system of a broadcasting television camera, video camera, or digital still camera, the image plane I corresponds to the imaging surface of an image sensor (photoelectric conversion element) that receives and photoelectrically converts an image formed by the zoom lens. In a case where the zoom lens is used as the imaging optical system of a film camera, the image plane I corresponds to the film surface to which the image formed by the zoom lens is exposed.

The first lens unit U1 corresponds to the first to fifteenth surfaces. The second lens unit U2 corresponds to the sixteenth to twenty-fourth surfaces. The third lens unit U3 corresponds to the twenty-fifth to twenty-seventh surfaces. The fourth lens unit U4 corresponds to the twenty-eighth to twenty-ninth surfaces. The fifth lens unit U5 corresponds to thirty-first to forty-eighth surfaces.

Table 1 summarizes the values for inequalities for the zoom lens according to this example. The zoom lens according to this example satisfies inequalities (1) to (12). By properly setting the paraxial amount of the first lens unit and the glass material of the first lens unit, this example can achieve high optical performance in the wavelength range from visible light to NIR light, a high zoom ratio, and a reduced size and weight.

### Example 4

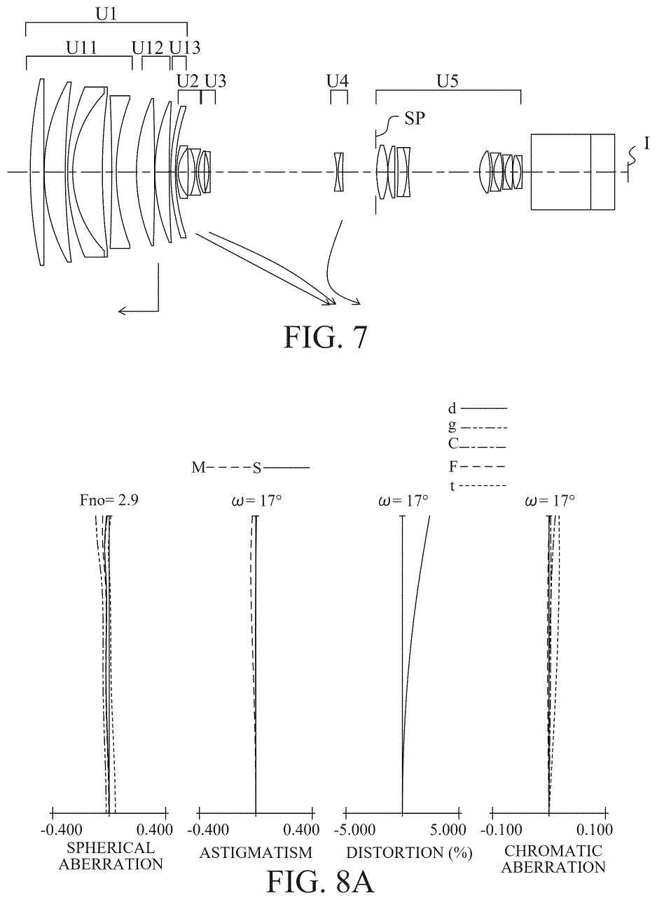

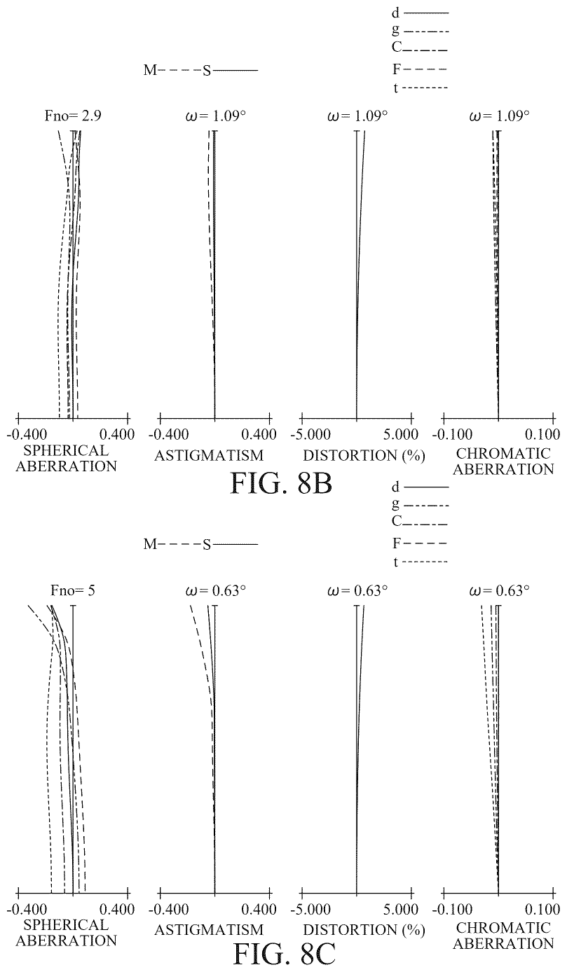

FIG. 7 is a sectional view of a zoom lens in an in-focus state at infinity at a wide-angle end according to Example 4 (numerical example 4) of this disclosure. FIGS. 8A, 8B, and 8C are longitudinal aberration diagrams of the zoom lens according to this example in the in-focus state at infinity at the wide-angle end, a focal length of 290.0 mm (middle zoom position), and a telephoto end, respectively.

The zoom lens according to this example includes, in order from the object side to the image side, a first lens unit U1, a second lens unit U2, a third lens unit U3, a fourth lens unit U4, and a fifth lens unit U5. The first lens unit U1 is a lens unit for focusing with positive refractive power that does not move for magnification variation. The second lens unit U2 is a lens unit for magnification variation with negative refractive power that moves toward the image side during magnification variation from the wide-angle end to the telephoto end. The third lens unit U3 is a lens unit with negative refractive power that moves during magnification variation from the wide-angle end to the telephoto end. The fourth lens unit U4 is a lens unit with negative refractive power that moves non-linearly on the optical axis in conjunction with the movement of the second lens unit U2 and the third lens unit U3, and correct image plane fluctuations associated with magnification variation. The fifth lens unit U5 is a lens unit (rear lens unit) with positive refractive power that performs an imaging function and does not move for magnification variation.

The first lens unit consists of a plurality of subunits, each distance between adjacent subunits changing during focusing. The plurality of subunits consist of, in order from the object side to the image side, a first subunit U11 that does not move for focusing, a second subunit U12 with positive refractive power that moves for focusing, and a third subunit U13 with negative refractive power that is adjacent to the second subunit on the image side.

In this example, the second lens unit U2, the third lens unit U3, and the fourth lens unit U4 form a magnification varying system (movable lens unit). SP represents an aperture stop that is included in the fifth lens unit U5 and is disposed closest to the object in the fifth lens unit U5. I represents an image plane. In a case where the zoom lens is used as the imaging optical system of a broadcasting television camera, video camera, or digital still camera, the image plane I corresponds to the imaging surface of an image sensor (photoelectric conversion element) that receives and photoelectrically converts an image formed by the zoom lens. In a case where the zoom lens is used as the imaging optical system of a film camera, the image plane I corresponds to the film surface to which the image formed by the zoom lens is exposed.

The first lens unit U1 corresponds to the first to fifteenth surfaces. The second lens unit U2 corresponds to the sixteenth to twentieth surfaces. The third lens unit U3 corresponds to the twenty-first to twenty-fourth surfaces. The fourth lens unit U4 corresponds to the twenty-fifth to twenty-seventh surfaces. The fifth lens unit U5 corresponds to the twenty-ninth to forty-sixth surfaces.

Table 1 summarizes the values for inequalities for the zoom lens according to this example. The zoom lens according to this example satisfies inequalities (1) to (12). By properly setting the paraxial amount of the first lens unit and the glass material of the first lens unit, this example can achieve high optical performance in the wavelength range from visible light to NIR light, a high zoom ratio, and a reduced size and weight.

### Example 5

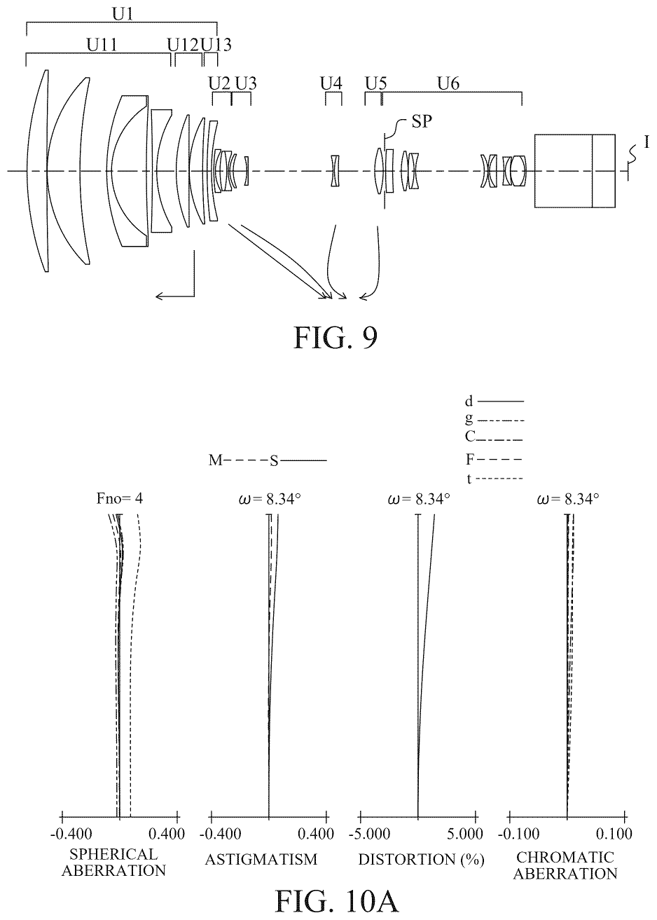

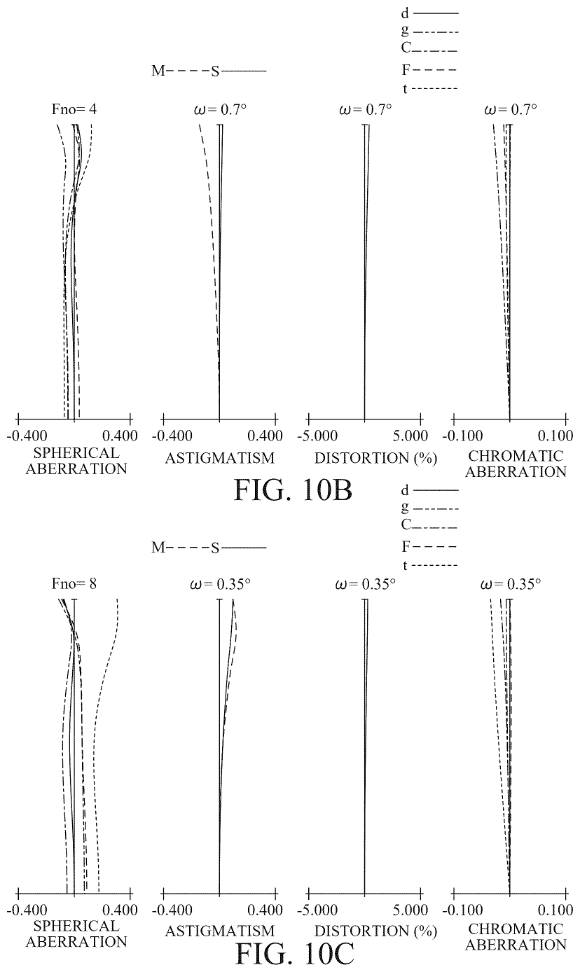

FIG. 9 is a sectional view of a zoom lens in an in-focus state at infinity at a wide-angle end according to Example 5 (numerical example 5) of this disclosure. FIGS. 10A, 10B, and 10C are longitudinal aberration diagrams of the zoom lens according to this example in the in-focus state at infinity at the wide-angle end, a focal length of 450.0 mm (middle zoom position), and a telephoto end.

The zoom lens according to this example includes, in order from the object side to the image side, a first lens unit U1, a second lens unit U2, a third lens unit U3, a fourth lens unit U4, a fifth lens unit U5, and a sixth lens unit U6. The first lens unit U1 is a lens unit for focusing with positive refractive power that does not move for magnification variation. The second lens unit U2 is a lens unit for magnification variation with negative refractive power that moves toward the image side for magnification variation from the wide-angle end to the telephoto end. The third lens unit U3 is a lens unit with negative refractive power that moves for magnification variation from the wide-angle end to the telephoto end. The fourth lens unit U4 is a lens unit with negative refractive power that moves for magnification variation from the wide-angle end to the telephoto end. The fifth lens unit U5 is a lens unit with positive refractive power that moves non-linearly on the optical axis in conjunction with the movement of the second lens unit U2, the third lens unit U3, and the fourth lens unit U4, and corrects image plane fluctuations associated with magnification variation. The sixth lens unit U6 is a lens unit (rear lens unit) with positive refractive power that performs an imaging function and does not move for magnification variation.

The first lens unit consists of a plurality of subunits in which each distance between adjacent subunits changes during focusing. The plurality of subunits consist of, in order from the object side to the image side, a first subunit U11 that does not move for focusing, a second subunit U12 with positive refractive power that moves for focusing, and a third subunit U13 with negative refractive power that is adjacent to the second subunit on the image side.

In this example, the second lens unit U2, third lens unit U3, fourth lens unit U4, and fifth lens unit U5 form a magnification varying system (movable lens unit). SP represents an aperture stop that is included in the sixth lens unit U6 and is disposed closest to the object in the sixth lens unit U6. I represents an image plane. In a case where the zoom lens is used as the imaging optical system of a broadcasting television camera, video camera, or digital still camera, the image plane I corresponds to the imaging surface of an image sensor (photoelectric conversion element) that receives and photoelectrically converts an image formed by the zoom lens. In a case where the zoom lens is used as the imaging optical system of a film camera, the image plane I corresponds to the film surface to which the image formed by the zoom lens is exposed.

The first lens unit U1 corresponds to the first to fifteenth surfaces. The second lens unit U2 corresponds to the sixteenth to twentieth surfaces. The third lens unit U3 corresponds to the twenty-first to twenty-fourth surfaces. The fourth lens unit U4 corresponds to the twenty-fifth to twenty-seventh surfaces. The fifth lens unit U5 corresponds to the twenty-eighth to twenty-ninth surfaces. The sixth lens unit U6 corresponds to the thirty-first to forty-eighth surfaces.

Table 1 summarizes the values for inequalities for the zoom lens according to this example. The zoom lens according to this example satisfies inequalities (1) to (12). By properly setting the paraxial amount of the first lens unit and the glass material of the first lens unit, this example can achieve high optical performance in the wavelength range from visible light to NIR light, a high zoom ratio, and a reduced size and weight.

### Example 6

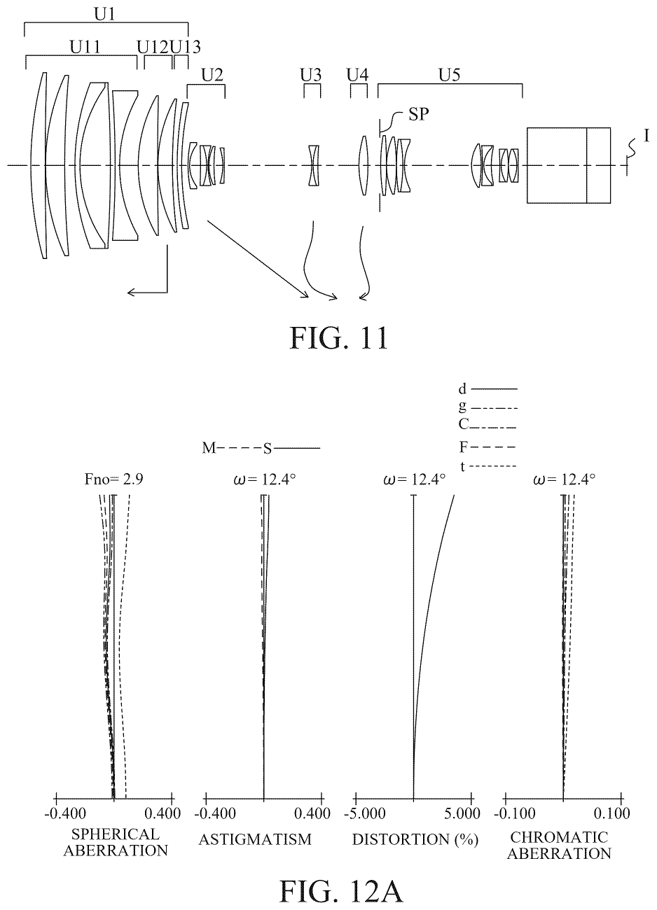

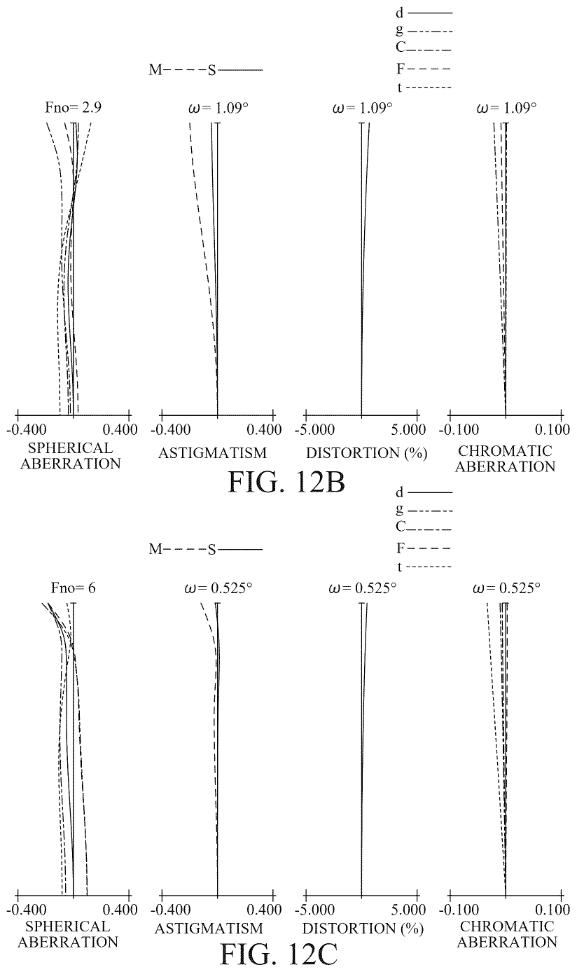

FIG. 11 is a sectional view of a zoom lens in an in-focus state at infinity at a wide-angle end according to Example 6 (numerical example 6) of this disclosure. FIGS. 12A, 12B, and 12C are longitudinal aberration diagrams of the zoom lens according to this example in the in-focus state at infinity at the wide-angle end, a focal length of 290.0 mm (middle zoom position), and a telephoto end, respectively.

The zoom lens according to this example includes, in order from the object side to the image side, a first lens unit U1, a second lens unit U2, a third lens unit U3, a fourth lens unit U4, and a fifth lens unit U5. The first lens unit U1 is a lens unit for focusing with positive refractive power that does not move for magnification variation. The second lens unit U2 is a lens unit for magnification variation with negative refractive power that moves toward the image side for magnification variation from the wide-angle end to the telephoto end. The third lens unit U3 is a lens unit with negative refractive power that moves for magnification variation from the wide-angle end to the telephoto end. The fourth lens unit U4 is a lens unit with positive refractive power that moves non-linearly on the optical axis in conjunction with the movement of the second lens unit U2 and the third lens unit U3, and corrects image plane fluctuations associated with magnification variation. The fifth lens unit U5 is a lens unit (rear lens unit) with positive refractive power that performs an imaging function and does not move for magnification variation.

The first lens unit consists of a plurality of subunits in which each distance between adjacent subunits changes during focusing. The plurality of subunits consist of, in order from the object side to the image side, a first subunit U11 that does not move for focusing, a second subunit U12 with positive refractive power that moves for focusing, and a third subunit U13 with negative refractive power that is adjacent to the second subunit on the image side.

In this example, the second lens unit U2, the third lens unit U3, and the fourth lens unit U4 form a magnification varying system (movable lens unit). SP represents an aperture stop that is included in the fifth lens unit U5 and is disposed closest to the object in the fifth lens unit U5. I represents an image plane. In a case where the zoom lens is used as the imaging optical system of a broadcasting television camera, video camera, or digital still camera, the image plane I corresponds to the imaging surface of an image sensor (photoelectric conversion element) that receives and photoelectrically converts an image formed by the zoom lens. In a case where the zoom lens is used as the imaging optical system of a film camera, the image plane I corresponds to the film surface to which the image formed by the zoom lens is exposed.

The first lens unit U1 corresponds to the first to fifteenth surfaces. The second lens unit U2 corresponds to the sixteenth to twenty-fourth surfaces. The third lens unit U3 corresponds to the twenty-fifth to twenty-seventh surfaces. The fourth lens unit U4 corresponds to the twenty-eighth to twenty-ninth surfaces. The fifth lens unit U5 corresponds to the thirty-first to forty-eighth surfaces.

Table 1 summarizes the values for inequalities for the zoom lens according to this example. The zoom lens according to this example satisfies inequalities (1) to (12). By properly setting the paraxial amount of the first lens unit and the glass material of the first lens unit, this example can achieve high optical performance in the wavelength range from visible light to NIR light, a high zoom ratio, and a reduced size and weight.

### Example 7

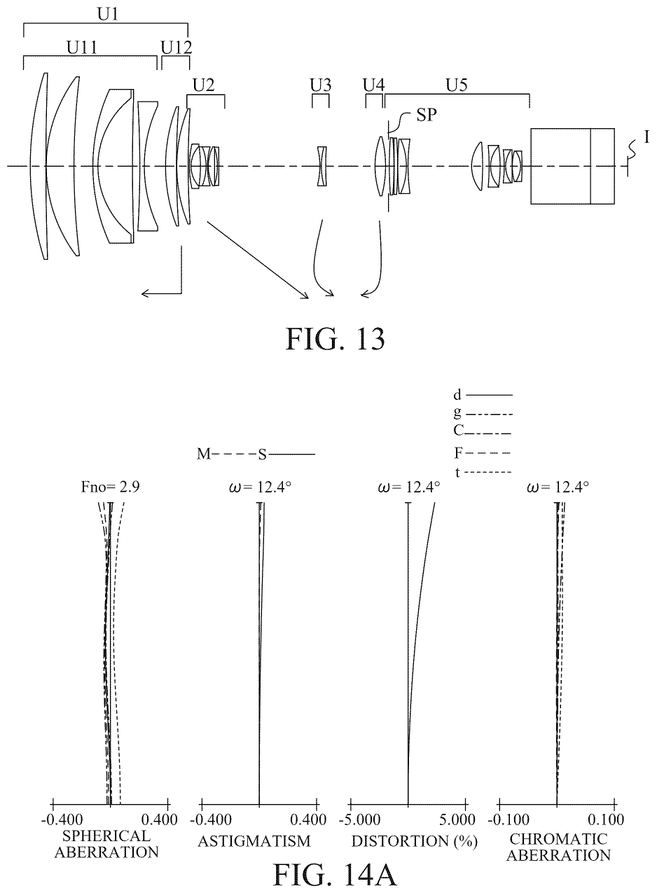

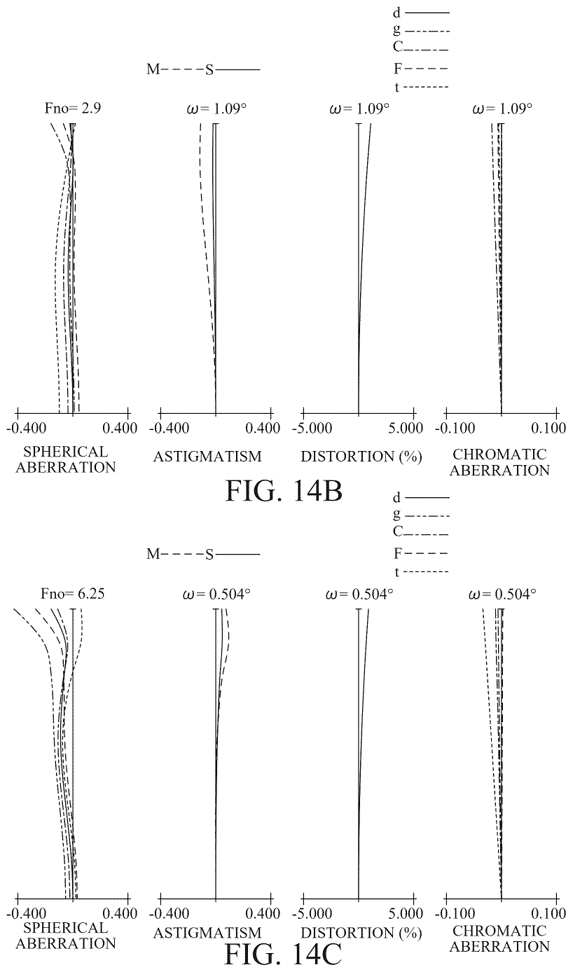

FIG. 13 is a sectional view of a zoom lens in an in-focus state at infinity at a wide-angle end according to Example 7 (numerical example 7) of this disclosure. FIGS. 14A, 14B, and 14C are longitudinal aberration diagrams of the zoom lens according to this example in the in-focus state at infinity at the wide-angle end, a focal length of 290.0 mm (middle zoom position), and a telephoto end, respectively.

The zoom lens according to this example includes, in order from the object side to the image side, a first lens unit U1, a second lens unit U2, a third lens unit U3, a fourth lens unit U4, and a fifth lens unit U5. The first lens unit U1 is a lens unit for focusing with positive refractive power that does not move for magnification variation. The second lens unit U2 is a lens unit for magnification variation with negative refractive power that moves toward the image side for magnification variation from the wide-angle end to the telephoto end. The third lens unit U3 is a lens unit with negative refractive power that moves for magnification variation from the wide-angle end to the telephoto end. The fourth lens unit U4 is a lens unit with positive refractive power that moves non-linearly on the optical axis in conjunction with the movement of the second lens unit U2 and the third lens unit U3, and corrects image plane fluctuations associated with magnification variation. The fifth lens unit U5 is a lens unit (rear lens unit) with positive refractive power that performs an imaging function and does not move for magnification variation.

The first lens unit consists of a plurality of subunits in which each distance between adjacent subunits changes during focusing. The plurality of subunits consist of, in order from the object side to the image side, a first subunit U11 that does not move for focusing, and a second subunit U12 with positive refractive power that moves for focusing.

In this example, the second lens unit U2, third lens unit U3, and fourth lens unit U4 form a magnification varying system (movable lens unit). SP represents an aperture stop, disposed closer to the object than the fifth lens unit U5. I represents an image plane. In a case where the zoom lens is used as the imaging optical system of a broadcasting television camera, video camera, or digital still camera, the image plane I corresponds to the imaging surface of an image sensor (photoelectric conversion element) that receives and photoelectrically converts an image formed by the zoom lens. In a case where the zoom lens is used as the imaging optical system of a film camera, the image plane I corresponds to the film surface to which the image formed by the zoom lens is exposed.

The first lens unit U1 corresponds to the first to thirteenth surfaces. The second lens unit U2 corresponds to the fourteenth to twenty-second surfaces. The third lens unit U3 corresponds to the twenty-third to twenty-fifth surfaces. The fourth lens unit U4 corresponds to the twenty-sixth to twenty-seventh surfaces. The fifth lens unit U5 corresponds to the twenty-ninth to twenty-sixth surfaces.

Table 1 summarizes the values for inequalities for the zoom lens according to this example. The zoom lens according to this example satisfies inequalities (1) to (12). By properly setting the paraxial amount of the first lens unit and the glass material of the first lens unit, this example can achieve high optical performance in the wavelength range from visible light to NIR light, a high zoom ratio, and a reduced size and weight.

Numerical examples 1 to 7 corresponding to Examples 1 to 7 will be discussed below. In each numerical example, i represents the order of the surface (optical surface) from the object side (surface number), ri represents a radius of curvature of an i-th surface counted from the object side, and di represents a gap (distance) on the optical axis between i-th and (i+1)-th surfaces from the object side. ndi and vdi indicate a refractive index for the d-line and an Abbe number of the medium (optical element) between i-th and (i+1)-th surfaces, respectively. BF represents an air-equivalent back focus. WIDE represents a wide-angle end, MIDDLE represents an intermediate zoom position, and TELE represents a telephoto end.

In a case where an optical surface is aspherical, an asterisk (*) is added to the right of the surface number. In a case where the X-axis is set to the optical axis direction, the H-axis is set orthogonal to the optical axis, a light traveling direction is positive, and “e-Z” means “×10^{-Z}.” The aspherical shape is expressed by the following equation:

$$X = \frac{{H}^{2} / R}{1 + \sqrt{1 - ( 1 + k ) {( H / R )}^{2}}} + A 4 \cdot {H}^{4} + A 6 \cdot {H}^{6} + A 8 \cdot {H}^{8} + A 10 \cdot {H}^{10} + A 12 \cdot {H}^{12} + A 14 \cdot {H}^{14} + A 16 \cdot {H}^{16} + A 3 \cdot {H}^{3} + A 5 \cdot {H}^{5} + A 7 \cdot {H}^{7} + A 9 \cdot {H}^{9} + A 11 \cdot {H}^{11} + A 13 \cdot {H}^{13} + A 15 \cdot {H}^{15}$$

where R is a paraxial radius of curvature, k is a conic constant, and A3 to A16 are aspherical coefficients.

NUMERICAL EXAMPLE 1
UNIT: mm
SURFACE DATA

| Surface No. | r | d | nd | vd | θCt |
|---|---|---|---|---|---|
| 1 | 172.654 | 7.99 | 1.59349 | 67.0 | 0.8494 |
| 2 | 770.147 | 0.20 | | | |
| 3 | 84.535 | 14.97 | 1.43387 | 95.1 | 0.8092 |
| 4 | 466.272 | 7.30 | | | |
| 5 | 90.128 | 2.80 | 1.69680 | 55.5 | 0.8330 |
| 6 | 53.608 | 14.57 | 1.43875 | 94.7 | 0.8410 |
| 7 | 185.821 | 5.96 | | | |
| 8 | 3008.160 | 2.50 | 1.74320 | 49.3 | 0.7979 |
| 9 | 68.188 | 13.44 | | | |
| 10 | 76.964 | 8.62 | 1.43387 | 95.1 | 0.8092 |
| 11 | 1808.219 | 0.20 | | | |
| 12 | 81.792 | 6.11 | 1.52841 | 76.5 | 0.8175 |
| 13 | 288.836 | 1.52 | | | |
| 14 | 122.876 | 2.50 | 1.65160 | 58.5 | 0.8525 |
| 15 | 96.649 | (Variable) | | | |
| 16 | 54.085 | 0.90 | 1.75106 | 43.1 | 0.7097 |
| 17 | 17.073 | 5.65 | | | |
| 18 | −64.804 | 3.24 | 1.80810 | 22.8 | 0.6596 |
| 19 | −27.351 | 0.80 | 1.69930 | 51.1 | 0.7593 |
| 20 | 43.387 | 0.50 | | | |
| 21 | 27.293 | 4.86 | 1.72047 | 34.7 | 0.7267 |
| 22 | −536.526 | 6.46 | | | |
| 23 | −31.965 | 0.80 | 1.59522 | 67.7 | 0.7953 |
| 24 | −8010.889 | (Variable) | | | |
| 25 | −39.326 | 0.80 | 1.71700 | 47.9 | 0.7629 |
| 26 | 42.443 | 2.37 | 1.84666 | 23.8 | 0.6614 |
| 27 | 243.296 | (Variable) | | | |
| 28 (SP) | ∞ | 0.50 | | | |
| 29 | 70.140 | 5.47 | 1.61800 | 63.3 | 0.8194 |
| 30* | −55.100 | 0.10 | | | |
| 31 | 45.202 | 6.12 | 1.43875 | 94.7 | 0.8410 |
| 32 | −47.982 | 0.55 | | | |
| 33 | −95.511 | 2.20 | 1.43875 | 94.7 | 0.8410 |
| 34 | −54.803 | 0.90 | 1.80100 | 35.0 | 0.7255 |
| 35 | 97.717 | 35.26 | | | |
| 36 | 19.805 | 6.17 | 1.43875 | 94.7 | 0.8410 |
| 37 | −134.166 | 2.64 | | | |
| 38 | −110.647 | 0.80 | 1.74100 | 52.6 | 0.8155 |
| 39 | 16.201 | 4.94 | 1.75106 | 43.1 | 0.7097 |
| 40 | −154.738 | 3.52 | | | |
| 41 | −66.224 | 0.80 | 1.85150 | 40.8 | 0.7392 |
| 42 | 15.201 | 3.82 | 1.54072 | 47.2 | 0.7766 |
| 43 | −121.667 | 0.10 | | | |
| 44 | 36.515 | 4.31 | 1.58144 | 40.8 | 0.7500 |
| 45 | −15.956 | 0.80 | 1.75106 | 43.1 | 0.7097 |
| 46 | −128.572 | 5.00 | | | |
| 47 | ∞ | 33.00 | 1.60859 | 46.4 | 0.7534 |
| 48 | ∞ | 13.20 | 1.51680 | 64.2 | 0.8687 |
| 49 | ∞ | 7.40 | | | |
| Image Plane | ∞ | | | | |

ASPHERIC DATA
30th Surface
K = 0.00000e+00 A 4 = 3.81160e−06 A 6 = 2.24829e−09 A 8 = 8.44910e−14
A10 = 3.84022e−15
VARIOUS DATA

| ZOOM RATIO | | 22.00 | |
|---|---|---|---|
| | WIDE | MIDDLE | TELE |
| Focal Length | 25.03 | 282.76 | 550.75 |
| Fno | 2.90 | 2.90 | 5.51 |
| Half Angle of View | 12.39 | 1.11 | 0.57 |
| Image Height | 5.50 | 5.50 | 5.50 |
| Overall Lens Length | 331.11 | 331.11 | 331.11 |
| BF | 7.40 | 7.40 | 7.40 |
| d15 | 0.89 | 59.89 | 64.85 |
| d24 | 61.67 | 2.70 | 11.76 |
| d27 | 15.89 | 15.86 | 1.84 |
| d49 | 7.40 | 7.40 | 7.40 |

ZOOM LENS UNIT DATA

| Lens Unit | Starting Surface | Focal Length |
|---|---|---|
| 1 | 1 | 155.31 |
| 2 | 16 | −19.28 |
| 3 | 25 | −53.39 |
| 4 | 28 | 39.28 |

NUMERICAL EXAMPLE 2
UNIT: mm
SURFACE DATA

| Surface No. | r | d | nd | vd | θCt |
|---|---|---|---|---|---|
| 1 | 165.573 | 10.06 | 1.59349 | 67.0 | 0.8494 |
| 2 | 1986.522 | 0.20 | | | |
| 3 | 78.401 | 15.91 | 1.43387 | 95.1 | 0.8092 |
| 4 | 318.263 | 2.48 | | | |
| 5 | 96.722 | 2.80 | 1.64000 | 60.1 | 0.8645 |
| 6 | 50.079 | 18.00 | 1.43875 | 94.7 | 0.8410 |
| 7 | 232.161 | 5.00 | | | |
| 8 | 1140.323 | 2.50 | 1.78800 | 47.4 | 0.7837 |
| 9 | 65.000 | 14.52 | | | |
| 10 | 70.796 | 8.97 | 1.43387 | 95.1 | 0.8092 |
| 11 | 801.537 | 0.20 | | | |
| 12 | 94.472 | 4.91 | 1.55200 | 70.7 | 0.8096 |
| 13 | 242.575 | 1.49 | | | |
| 14 | 112.802 | 2.50 | 1.67300 | 38.3 | 0.7481 |
| 15 | 100.806 | (Variable) | | | |
| 16 | 107.555 | 0.90 | 1.75106 | 43.1 | 0.7097 |
| 17 | 19.442 | 4.61 | | | |
| 18 | −150.127 | 3.51 | 1.80810 | 22.8 | 0.6596 |
| 19 | −29.659 | 0.80 | 1.69930 | 51.1 | 0.7593 |
| 20 | 44.949 | 0.50 | | | |
| 21 | 27.135 | 3.01 | 1.72047 | 34.7 | 0.7267 |
| 22 | 152.839 | 1.90 | | | |
| 23 | −34.918 | 0.80 | 1.59522 | 67.7 | 0.7953 |
| 24 | 1028.227 | (Variable) | | | |
| 25 | −34.996 | 0.80 | 1.69930 | 51.1 | 0.7593 |
| 26 | 32.390 | 2.53 | 1.85478 | 24.8 | 0.6739 |
| 27 | 140.791 | (Variable) | | | |
| 28* | 34.829 | 5.65 | 1.59410 | 60.5 | 0.7789 |
| 29 | −77.991 | (Variable) | | | |
| 30 (SP) | ∞ | 0.50 | | | |
| 31 | 99.182 | 2.00 | 1.70300 | 52.4 | 0.7819 |
| 32 | 194.008 | 0.10 | | | |
| 33 | 59.782 | 4.07 | 1.43875 | 94.7 | 0.8410 |
| 34 | −91.526 | 0.80 | | | |
| 35 | 70.137 | 3.91 | 1.43875 | 94.7 | 0.8410 |
| 36 | −56.466 | 0.90 | 1.80100 | 35.0 | 0.7255 |
| 37 | 34.275 | 37.32 | | | |
| 38 | 47.857 | 4.07 | 1.49700 | 81.5 | 0.8258 |
| 39 | −35.122 | 0.74 | | | |
| 40 | −46.831 | 0.80 | 1.74100 | 52.6 | 0.8155 |
| 41 | 29.136 | 3.48 | 1.75106 | 43.1 | 0.7097 |
| 42 | −83.085 | 7.59 | | | |
| 43 | −45.955 | 0.80 | 1.88300 | 40.8 | 0.7397 |
| 44 | 18.300 | 4.05 | 1.54072 | 47.2 | 0.7766 |
| 45 | −73.159 | 0.10 | | | |
| 46 | 22.758 | 4.42 | 1.58144 | 40.8 | 0.7500 |
| 47 | −40.290 | 0.80 | 1.75106 | 43.1 | 0.7097 |
| 48 | −204.111 | 5.00 | | | |
| 49 | ∞ | 33.00 | 1.60859 | 46.4 | 0.7534 |
| 50 | ∞ | 13.20 | 1.51680 | 64.2 | 0.8687 |
| 51 | ∞ | 7.40 | | | |
| Image Plane | ∞ | | | | |

ASPHERIC DATA
28th Surface
K = 0.00000e+00 A 4 = − 7.68084e−06 A 6 = − 2.93238e−11 A 8 = 1.22417e−12
A10 = − 5.96113e−15
VARIOUS DATA

| ZOOM RATIO | | 24.97 | |
|---|---|---|---|
| | WIDE | MIDDLE | TELE |
| Focal Length | 25.01 | 302.16 | 624.51 |
| Fno | 2.91 | 2.91 | 6.00 |
| Half Angle of View | 12.40 | 1.04 | 0.50 |
| Image Height | 5.50 | 5.50 | 5.50 |
| Overall Lens Length | 331.07 | 331.07 | 331.07 |
| BF | 7.40 | 7.40 | 7.40 |
| d15 | 1.55 | 58.97 | 63.31 |
| d24 | 57.34 | 3.22 | 5.69 |
| d27 | 21.56 | 17.09 | 0.98 |
| d29 | 1.00 | 2.16 | 11.47 |
| d51 | 7.40 | 7.40 | 7.40 |

ZOOM LENS UNIT DATA

| Lens Unit | Starting Surface | Focal Length |
|---|---|---|
| 1 | 1 | 153.69 |
| 2 | 16 | −20.56 |
| 3 | 25 | −46.75 |
| 4 | 28 | 41.30 |
| 5 | 30 | 91.20 |

NUMERICAL EXAMPLE 3
UNIT: mm
SURFACE DATA

| Surface No. | r | d | nd | vd | θCt |
|---|---|---|---|---|---|
| 1 | 162.029 | 9.83 | 1.59349 | 67.0 | 0.8494 |
| 2 | 4485.773 | 0.20 | | | |
| 3 | 74.470 | 15.35 | 1.43387 | 95.1 | 0.8092 |
| 4 | 292.678 | 2.33 | | | |
| 5 | 103.349 | 2.80 | 1.65160 | 58.5 | 0.8525 |
| 6 | 48.328 | 17.20 | 1.43875 | 94.7 | 0.8410 |
| 7 | 218.847 | 5.33 | | | |
| 8 | 3180.470 | 2.50 | 1.78800 | 47.4 | 0.7837 |
| 9 | 69.473 | 14.71 | | | |
| 10 | 79.631 | 7.16 | 1.43387 | 95.1 | 0.8092 |
| 11 | 456.521 | 0.20 | | | |
| 12 | 90.139 | 5.84 | 1.55200 | 70.7 | 0.8096 |
| 13 | 400.735 | 1.50 | | | |
| 14 | 137.969 | 2.50 | 1.67300 | 38.3 | 0.7481 |
| 15 | 129.627 | (Variable) | | | |
| 16 | 97.524 | 0.90 | 1.75106 | 43.1 | 0.7097 |
| 17 | 18.612 | 4.76 | | | |
| 18 | −95.353 | 3.27 | 1.80810 | 22.8 | 0.6596 |
| 19 | −29.264 | 0.80 | 1.69930 | 51.1 | 0.7593 |
| 20 | 51.917 | 0.50 | | | |
| 21 | 27.835 | 3.17 | 1.72047 | 34.7 | 0.7267 |
| 22 | 639.510 | 1.52 | | | |
| 23 | −38.461 | 0.80 | 1.59522 | 67.7 | 0.7953 |
| 24 | 221.579 | (Variable) | | | |
| 25 | −38.374 | 0.80 | 1.69930 | 51.1 | 0.7593 |
| 26 | 33.956 | 2.54 | 1.85478 | 24.8 | 0.6739 |
| 27 | 153.953 | (Variable) | | | |
| 28* | 42.553 | 5.56 | 1.59410 | 60.5 | 0.7789 |
| 29 | −72.047 | (Variable) | | | |
| 30 (SP) | ∞ | 0.50 | | | |
| 31 | 127.736 | 2.34 | 1.70300 | 52.4 | 0.7819 |
| 32 | −5566.630 | 0.09 | | | |
| 33 | 76.601 | 3.56 | 1.43875 | 94.7 | 0.8410 |
| 34 | −127.929 | 0.09 | | | |
| 35 | 79.371 | 4.00 | 1.43875 | 94.7 | 0.8410 |
| 36 | −59.818 | 0.90 | 1.80100 | 35.0 | 0.7255 |
| 37 | 38.846 | 36.30 | | | |
| 38 | 26.763 | 4.89 | 1.49700 | 81.5 | 0.8258 |
| 39 | −57.994 | 0.62 | | | |
| 40 | −123.277 | 0.80 | 1.74100 | 52.6 | 0.8155 |
| 41 | 17.043 | 3.76 | 1.75106 | 43.1 | 0.7097 |
| 42 | 84.294 | 8.20 | | | |
| 43 | −78.706 | 0.80 | 1.88300 | 40.8 | 0.7397 |
| 44 | 22.173 | 3.60 | 1.54072 | 47.2 | 0.7766 |
| 45 | −56.074 | 0.10 | | | |
| 46 | 35.687 | 4.33 | 1.58144 | 40.8 | 0.7500 |
| 47 | −19.440 | 0.80 | 1.75106 | 43.1 | 0.7097 |
| 48 | −98.513 | 5.00 | | | |
| 49 | ∞ | 33.00 | 1.60859 | 46.4 | 0.7534 |
| 50 | ∞ | 13.20 | 1.51680 | 64.2 | 0.8687 |
| 51 | ∞ | 7.41 | | | |
| Image Plane | ∞ | | | | |

ASPHERIC DATA
28th Surface
K = 0.00000e+00 A 4 = − 4.84502e−06 A 6 = 1.61487e−10 A 8 = 1.44495e−12
A10 = − 3.50354e−15
VARIOUS DATA

| ZOOM RATIO | | 24.97 | |
|---|---|---|---|
| | WIDE | MIDDLE | TELE |
| Focal Length | 25.02 | 290.23 | 624.68 |
| Fno | 2.90 | 2.91 | 6.25 |
| Half Angle of View | 12.40 | 1.09 | 0.50 |
| Image Height | 5.50 | 5.50 | 5.50 |
| Overall Lens Length | 331.07 | 331.07 | 331.07 |
| BF | 7.41 | 7.41 | 7.41 |
| d15 | 1.30 | 58.13 | 62.56 |
| d24 | 57.19 | 4.54 | 8.03 |
| d27 | 25.23 | 19.91 | 0.98 |
| d29 | 0.99 | 2.13 | 13.13 |
| d51 | 7.41 | 7.41 | 7.41 |

ZOOM LENS UNIT DATA

| Lens Unit | Starting Surface | Focal Length |
|---|---|---|
| 1 | 1 | 149.03 |
| 2 | 16 | −21.04 |
| 3 | 25 | −51.79 |
| 4 | 28 | 45.86 |
| 5 | 30 | 105.82 |

NUMERICAL EXAMPLE 4
UNIT: mm
SURFACE DATA

| Surface No. | r | d | nd | vd | θCt |
|---|---|---|---|---|---|
| 1 | 237.151 | 7.49 | 1.59349 | 67.0 | 0.8494 |
| 2 | 34685.414 | 0.20 | | | |
| 3 | 100.832 | 11.69 | 1.43387 | 95.1 | 0.8092 |
| 4 | 367.213 | 1.31 | | | |
| 5 | 119.649 | 2.80 | 1.69680 | 55.5 | 0.8330 |
| 6 | 62.271 | 16.42 | 1.43875 | 94.7 | 0.8410 |
| 7 | 334.184 | 5.19 | | | |
| 8 | −989.166 | 2.50 | 1.77250 | 49.6 | 0.7955 |
| 9 | 110.841 | 11.19 | | | |
| 10 | 101.000 | 10.04 | 1.43387 | 95.1 | 0.8092 |
| 11 | −1249.065 | 0.20 | | | |
| 12 | 97.587 | 7.92 | 1.53775 | 74.7 | 0.8203 |
| 13 | 641.581 | 0.88 | | | |
| 14 | 119.713 | 2.50 | 1.64000 | 60.1 | 0.8645 |
| 15 | 108.795 | (Variable) | | | |
| 16 | 52.880 | 0.90 | 1.75106 | 43.1 | 0.7097 |
| 17 | 19.287 | 5.45 | | | |
| 18 | −318.705 | 3.79 | 1.80810 | 22.8 | 0.6596 |
| 19 | −33.835 | 0.80 | 1.69930 | 51.1 | 0.7593 |
| 20 | 31.421 | (Variable) | | | |
| 21 | 25.545 | 3.15 | 1.72047 | 34.7 | 0.7267 |
| 22 | 95.195 | 2.49 | | | |
| 23 | −31.323 | 0.80 | 1.59522 | 67.7 | 0.7953 |
| 24 | −43683.005 | (Variable) | | | |
| 25 | −37.273 | 0.80 | 1.71700 | 47.9 | 0.7629 |
| 26 | 36.770 | 2.49 | 1.84666 | 23.8 | 0.6614 |
| 27 | 198.363 | (Variable) | | | |
| 28(SP) | ∞ | 0.50 | | | |
| 29 | 51.774 | 6.16 | 1.61800 | 63.3 | 0.8194 |
| 30* | −43.913 | 0.10 | | | |
| 31 | 42.921 | 3.80 | 1.43875 | 94.7 | 0.8410 |
| 32 | −2266.651 | 1.77 | | | |
| 33 | −170.161 | 4.95 | 1.43875 | 94.7 | 0.8410 |
| 34 | −43.961 | 0.90 | 1.80100 | 35.0 | 0.7255 |
| 35 | 104.016 | 39.28 | | | |
| 36 | 19.082 | 5.87 | 1.43875 | 94.7 | 0.8410 |
| 37 | −51.639 | 1.28 | | | |
| 38 | −43.257 | 0.80 | 1.74100 | 52.6 | 0.8155 |
| 39 | 18.109 | 4.82 | 1.75106 | 43.1 | 0.7097 |
| 40 | −43.894 | 0.65 | | | |
| 41 | −63.439 | 0.80 | 1.85150 | 40.8 | 0.7392 |
| 42 | 15.716 | 4.12 | 1.54072 | 47.2 | 0.7766 |
| 43 | −111.765 | 0.10 | | | |
| 44 | 41.979 | 4.41 | 1.58144 | 40.8 | 0.7500 |
| 45 | −16.765 | 0.80 | 1.75106 | 43.1 | 0.7097 |
| 46 | −212.208 | 5.00 | | | |
| 47 | ∞ | 33.00 | 1.60859 | 46.4 | 0.7534 |
| 48 | ∞ | 13.20 | 1.51680 | 64.2 | 0.8687 |
| 49 | ∞ | 7.40 | | | |
| Image Plane | ∞ | | | | |

ASPHERIC DATA
30th Surface
K = 0.00000e+00 A 4 = 2.98138e−06 A 6 = 2.06665e−09 A 8 = − 8.55329e−12
A10 = 1.89955e−14
VARIOUS DATA

| ZOOM RATIO | | 27.78 | |
|---|---|---|---|
| | WIDE | MIDDLE | TELE |
| Focal Length | 18.00 | 290.00 | 500.00 |
| Fno | 2.90 | 2.90 | 5.00 |
| Half Angle of View | 16.99 | 1.09 | 0.63 |
| Image Height | 5.50 | 5.50 | 5.50 |
| Overall Lens Length | 331.07 | 331.07 | 331.07 |
| BF | 7.40 | 7.40 | 7.40 |
| d15 | 0.72 | 69.77 | 73.30 |
| d20 | 1.18 | 2.34 | 1.82 |
| d24 | 70.11 | 3.58 | 13.27 |
| d27 | 18.32 | 14.63 | 1.93 |
| d49 | 7.40 | 7.40 | 7.40 |

ZOOM LENS UNIT DATA

| Lens Unit | Starting Surface | Focal Length |
|---|---|---|
| 1 | 1 | 142.45 |
| 2 | 16 | −19.97 |
| 3 | 21 | 249.22 |
| 4 | 25 | −49.81 |
| 5 | 28 | 46.96 |

NUMERICAL EXAMPLE 5
UNIT: mm
SURFACE DATA

| Surface No. | r | d | nd | vd | θCt |
|---|---|---|---|---|---|
| 1 | 163.767 | 11.37 | 1.59349 | 67.0 | 0.8494 |
| 2 | 1984.287 | 0.20 | | | |
| 3 | 75.134 | 18.84 | 1.43387 | 95.1 | 0.8092 |
| 4 | 247.015 | 15.40 | | | |
| 5 | 109.239 | 2.80 | 1.65160 | 58.5 | 0.8525 |
| 6 | 44.157 | 20.02 | 1.43875 | 94.7 | 0.8410 |
| 7 | 656.052 | 3.44 | | | |
| 8 | −1027.256 | 2.50 | 1.78800 | 47.4 | 0.7837 |
| 9 | 63.579 | 11.19 | | | |
| 10 | 82.493 | 7.37 | 1.43387 | 95.1 | 0.8092 |
| 11 | 5790.778 | 0.20 | | | |
| 12 | 62.179 | 7.67 | 1.55200 | 70.7 | 0.8096 |
| 13 | 379.670 | 2.54 | | | |
| 14 | 244.762 | 2.50 | 1.67300 | 38.3 | 0.7481 |
| 15 | 109.716 | (Variable) | | | |
| 16* | 92.614 | 0.90 | 1.75106 | 43.1 | 0.7097 |
| 17 | 21.810 | 2.67 | | | |
| 18 | 53.392 | 3.85 | 1.80810 | 22.8 | 0.6596 |
| 19 | −56.684 | 0.80 | 1.69930 | 51.1 | 0.7593 |
| 20 | 24.953 | (Variable) | | | |
| 21 | 18.306 | 1.95 | 1.72047 | 34.7 | 0.7267 |
| 22 | 24.379 | 7.80 | | | |
| 23 | −26.554 | 0.80 | 1.59522 | 67.7 | 0.7953 |
| 24 | −406.762 | (Variable) | | | |
| 25 | −35.799 | 0.80 | 1.69930 | 51.1 | 0.7593 |
| 26 | 31.834 | 2.26 | 1.85478 | 24.8 | 0.6739 |
| 27 | 128.510 | (Variable) | | | |
| 28* | 35.413 | 4.89 | 1.59410 | 60.5 | 0.7789 |
| 29 | −49.539 | (Variable) | | | |
| 30 (SP) | ∞ | 0.62 | | | |
| 31 | 169.754 | 4.06 | 1.70300 | 52.4 | 0.7819 |
| 32 | 186.032 | 4.97 | | | |
| 33 | 40.199 | 3.89 | 1.43875 | 94.7 | 0.8410 |
| 34 | −49.514 | 0.09 | | | |
| 35 | 71.650 | 3.35 | 1.43875 | 94.7 | 0.8410 |
| 36 | −34.541 | 0.90 | 1.80100 | 35.0 | 0.7255 |
| 37 | 28.664 | 39.49 | | | |
| 38 | −21.920 | 2.11 | 1.49700 | 81.5 | 0.8258 |
| 39 | −17.567 | 0.10 | | | |
| 40 | 34.495 | 0.80 | 1.74100 | 52.6 | 0.8155 |
| 41 | 13.968 | 3.98 | 1.75106 | 43.1 | 0.7097 |
| 42 | 431.711 | 4.29 | | | |
| 43 | −49.272 | 0.80 | 1.88300 | 40.8 | 0.7397 |
| 44 | 12.761 | 2.89 | 1.54072 | 47.2 | 0.7766 |
| 45 | 39.315 | 0.10 | | | |
| 46 | 17.677 | 8.20 | 1.58144 | 40.8 | 0.7500 |
| 47 | −14.193 | 0.80 | 1.75106 | 43.1 | 0.7097 |
| 48 | −39.353 | 5.00 | | | |
| 49 | ∞ | 33.00 | 1.60859 | 46.4 | 0.7534 |
| 50 | ∞ | 13.20 | 1.51680 | 64.2 | 0.8687 |
| 51 | ∞ | 7.40 | | | |
| Image Plane | ∞ | | | | |

ASPHERIC DATA
16th Surface
K = 0.00000e+00 A 4 = − 3.58875e−07 A 6 = 1.54149e−09 A 8 = − 1.38948e−11
A10 = 4.84508e−14
28th Surface
K = 0.00000e+00 A 4 = − 1.04483e−05 A 6 = 1.79167e−09 A 8 = − 9.89538e−12
A10 = 2.55881e−14
VARIOUS DATA

| ZOOM RATIO | | 24.00 | |
|---|---|---|---|
| | WIDE | MIDDLE | TELE |
| Focal Length | 37.50 | 449.99 | 899.98 |
| Fno | 4.00 | 4.00 | 8.00 |
| Half Angle of View | 8.34 | 0.70 | 0.35 |
| Image Height | 5.50 | 5.50 | 5.50 |
| Overall Lens Length | 345.65 | 345.65 | 345.65 |
| BF | 7.40 | 7.40 | 7.40 |
| d15 | 1.37 | 49.51 | 52.76 |
| d20 | 0.99 | 1.17 | 1.73 |
| d24 | 48.79 | 2.57 | 2.55 |
| d27 | 20.89 | 15.37 | 0.74 |
| d29 | 0.80 | 4.24 | 15.06 |
| d51 | 7.40 | 7.40 | 7.40 |

ZOOM LENS UNIT DATA

| Lens Unit | Starting Surface | Focal Length |
|---|---|---|
| 1 | 1 | 167.53 |
| 2 | 16 | −25.95 |
| 3 | 21 | −141.48 |
| 4 | 25 | −46.65 |
| 5 | 28 | 35.52 |
| 6 | 30 | 137.21 |

NUMERICAL EXAMPLE 6
UNIT: mm
SURFACE DATA

| Surface No. | r | d | nd | vd | θCt |
|---|---|---|---|---|---|
| 1 | 195.458 | 7.98 | 1.59349 | 67.0 | 0.8494 |
| 2 | 1719.564 | 0.20 | | | |
| 3 | 120.303 | 10.63 | 1.43387 | 95.1 | 0.8092 |
| 4 | 559.181 | 5.68 | | | |
| 5 | 126.111 | 2.80 | 1.64000 | 60.1 | 0.8645 |
| 6 | 74.431 | 16.88 | 1.43875 | 94.7 | 0.8410 |
| 7 | −699.962 | 2.66 | | | |
| 8 | −582.381 | 2.50 | 1.74320 | 49.3 | 0.7979 |
| 9 | 78.889 | 10.31 | | | |
| 10 | 77.476 | 10.78 | 1.43387 | 95.1 | 0.8092 |
| 11 | 1773.351 | 0.20 | | | |
| 12 | 77.026 | 8.06 | 1.52841 | 76.5 | 0.8175 |
| 13 | 291.879 | 2.60 | | | |
| 14 | 189.257 | 2.50 | 1.67300 | 38.3 | 0.7481 |
| 15 | 155.940 | (Variable) | | | |
| 16 | 63.021 | 0.90 | 1.75106 | 43.1 | 0.7097 |
| 17 | 18.769 | 6.05 | | | |
| 18 | −266.160 | 3.41 | 1.80810 | 22.8 | 0.6596 |
| 19 | −31.833 | 0.80 | 1.69930 | 51.1 | 0.7593 |
| 20 | 37.039 | 0.50 | | | |
| 21 | 24.960 | 2.77 | 1.72047 | 34.7 | 0.7267 |
| 22 | 81.516 | 4.88 | | | |
| 23 | −31.273 | 0.80 | 1.59522 | 67.7 | 0.7953 |
| 24 | −485.396 | (Variable) | | | |
| 25 | −33.874 | 0.80 | 1.69930 | 51.1 | 0.7593 |
| 26 | 33.391 | 2.63 | 1.85478 | 24.8 | 0.6739 |
| 27 | 139.899 | (Variable) | | | |
| 28* | 48.780 | 5.01 | 1.59410 | 60.5 | 0.7789 |
| 29 | −92.719 | (Variable) | | | |
| 30 (SP) | ∞ | 0.50 | | | |
| 31 | 100.052 | 3.21 | 1.70300 | 52.4 | 0.7819 |
| 32 | −237.631 | 0.08 | | | |
| 33 | 39.579 | 5.41 | 1.43875 | 94.7 | 0.8410 |
| 34 | −105.017 | 0.09 | | | |
| 35 | 101.602 | 3.51 | 1.43875 | 94.7 | 0.8410 |
| 36 | −80.482 | 0.90 | 1.80100 | 35.0 | 0.7255 |
| 37 | 29.000 | 37.27 | | | |
| 38 | 21.900 | 5.34 | 1.49700 | 81.5 | 0.8258 |
| 39 | −67.554 | 0.69 | | | |
| 40 | −149.146 | 0.80 | 1.74100 | 52.6 | 0.8155 |
| 41 | 13.223 | 4.12 | 1.75106 | 43.1 | 0.7097 |
| 42 | 43.026 | 4.73 | | | |
| 43 | −154.021 | 0.80 | 1.88300 | 40.8 | 0.7397 |
| 44 | 17.957 | 3.95 | 1.54072 | 47.2 | 0.7766 |
| 45 | −56.463 | 0.10 | | | |
| 46 | 26.593 | 4.63 | 1.58144 | 40.8 | 0.7500 |
| 47 | −19.704 | 0.80 | 1.75106 | 43.1 | 0.7097 |
| 48 | −253.637 | 5.00 | | | |
| 49 | ∞ | 33.00 | 1.60859 | 46.4 | 0.7534 |
| 50 | ∞ | 13.20 | 1.51680 | 64.2 | 0.8687 |
| 51 | ∞ | 9.11 | | | |
| Image Plane | ∞ | | | | |

ASPHERIC DATA
28th Surface
K = 0.00000e+00 A 4 = − 4.93196e−06 A 6 = 1.66622e−11 A 8 = 2.95956e−12
A10 = − 6.30782e−15
VARIOUS DATA

| ZOOM RATIO | | 24.00 | |
|---|---|---|---|
| | WIDE | MIDDLE | TELE |
| Focal Length | 25.00 | 289.98 | 599.97 |
| Fno | 2.90 | 2.90 | 6.00 |
| Half Angle of View | 12.41 | 1.09 | 0.53 |
| Image Height | 5.50 | 5.50 | 5.50 |
| Overall Lens Length | 331.07 | 331.07 | 331.07 |
| BF | 9.11 | 9.11 | 9.11 |
| d15 | 3.52 | 58.27 | 62.44 |
| d24 | 48.59 | 5.06 | 9.67 |
| d27 | 22.80 | 17.21 | 0.92 |
| d29 | 6.59 | 0.97 | 8.47 |
| d51 | 9.11 | 9.11 | 9.11 |

ZOOM LENS UNIT DATA

| Lens Unit | Starting Surface | Focal Length |
|---|---|---|
| 1 | 1 | 133.91 |
| 2 | 16 | −19.80 |
| 3 | 25 | −44.94 |
| 4 | 28 | 54.52 |
| 5 | 30 | 85.92 |

NUMERICAL EXAMPLE 7
UNIT: mm
SURFACE DATA

| Surface No. | r | d | nd | vd | θCt |
|---|---|---|---|---|---|
| 1 | 174.179 | 8.65 | 1.48749 | 70.2 | 0.8924 |
| 2 | 1410.322 | 0.20 | | | |
| 3 | 81.019 | 15.36 | 1.43387 | 95.1 | |
| 4 | 398.758 | 10.47 | | | |
| 5 | 101.493 | 2.80 | 1.65160 | 58.5 | 0.8525 |
| 6 | 47.502 | 19.16 | 1.43875 | 94.7 | 0.8410 |
| 7 | 1142.319 | 4.04 | | | |
| 8 | −599.701 | 2.50 | 1.74320 | 49.3 | 0.7979 |
| 9 | 78.371 | 11.78 | | | |
| 10 | 91.414 | 6.04 | 1.43387 | 95.1 | 0.8092 |
| 11 | 442.575 | 0.20 | | | |
| 12 | 84.169 | 6.30 | 1.52841 | 76.5 | 0.8175 |
| 13 | 480.356 | (Variable) | | | |
| 14 | 55.326 | 0.90 | 1.75106 | 43.1 | 0.7097 |
| 15 | 16.260 | 5.16 | | | |
| 16 | −77.586 | 3.12 | 1.80810 | 22.8 | 0.6596 |
| 17 | −28.643 | 0.80 | 1.69930 | 51.1 | 0.7593 |
| 18 | 39.662 | 0.50 | | | |
| 19 | 24.602 | 3.43 | 1.72047 | 34.7 | 0.7267 |
| 20 | 5172.967 | 1.59 | | | |
| 21 | −33.889 | 0.80 | 1.59522 | 67.7 | 0.7953 |
| 22 | −499.178 | (Variable) | | | |
| 23 | −40.079 | 0.80 | 1.69930 | 51.1 | 0.7593 |
| 24 | 39.902 | 2.40 | 1.85478 | 24.8 | 0.6739 |
| 25 | 172.305 | (Variable) | | | |
| 26* | 46.212 | 5.84 | 1.59410 | 60.5 | 0.7789 |
| 27 | −64.578 | (Variable) | | | |
| 28 (SP) | ∞ | 0.50 | | | |
| 29 | 224.287 | 2.58 | 1.70300 | 52.4 | 0.7819 |
| 30 | −184.815 | 0.09 | | | |
| 31 | −2493.121 | 1.93 | 1.43875 | 94.7 | 0.8410 |
| 32 | −218.954 | 0.09 | | | |
| 33 | 155.295 | 4.79 | 1.43875 | 94.7 | 0.8410 |
| 34 | −36.725 | 0.90 | 1.80100 | 35.0 | 0.7255 |
| 35 | 103.499 | 35.22 | | | |
| 36 | 20.620 | 6.09 | 1.43875 | 94.7 | 0.8410 |
| 37 | −155.832 | 3.63 | | | |
| 38 | −120.375 | 0.80 | 1.74100 | 52.6 | 0.8155 |
| 39 | 15.939 | 5.31 | 1.75106 | 43.1 | 0.7097 |
| 40 | −73.181 | 2.28 | | | |
| 41 | −72.530 | 0.80 | 1.88300 | 40.8 | 0.7397 |
| 42 | 15.365 | 3.57 | 1.54072 | 47.2 | 0.7766 |
| 43 | −557.053 | 0.10 | | | |
| 44 | 32.102 | 4.54 | 1.58144 | 40.8 | 0.7500 |
| 45 | −14.442 | 0.80 | 1.75106 | 43.1 | 0.7097 |
| 46 | −166.884 | 5.00 | | | |
| 47 | ∞ | 33.00 | 1.60859 | 46.4 | 0.7534 |
| 48 | ∞ | 13.20 | 1.51680 | 64.2 | 0.8687 |
| 49 | ∞ | 7.40 | | | |
| Image Plane | ∞ | | | | |

ASPHERIC DATA
26th Surface
K = 0.00000e+00 A 4 = − 2.41388e−06 A 6 = 2.14481e−10 A 8 = 2.22420e−12
A10 = − 4.11392e−15
VARIOUS DATA

| | |
|---|---|
| ZOOM RATIO | 25.00 |

| | WIDE | MIDDLE | TELE |
|---|---|---|---|
| Focal Length | 25.00 | 289.99 | 624.99 |
| Fno | 2.90 | 2.90 | 6.25 |
| Half Angle of View | 12.41 | 1.09 | 0.50 |
| Image Height | 5.50 | 5.50 | 5.50 |
| Overall Lens Length | 331.07 | 331.07 | 331.07 |
| BF | 7.40 | 7.40 | 7.40 |
| d13 | 0.70 | 58.39 | 62.71 |
| d22 | 56.01 | 5.12 | 13.01 |
| d25 | 27.31 | 21.11 | 0.98 |
| d27 | 1.59 | 0.99 | 8.91 |
| d49 | 7.40 | 7.40 | 7.40 |

ZOOM LENS UNIT DATA

| Lens Unit | Starting Surface | Focal Length |
|---|---|---|
| 1 | 1 | 146.27 |
| 2 | 14 | −21.38 |
| 3 | 23 | −53.74 |
| 4 | 26 | 46.25 |
| 5 | 28 | 144.47 |

TABLE 1

| | | EX. 1 | EX. 2 | EX. 3 | EX. 4 | EX. 5 | EX. 6 | EX.7 |
|---|---|---|---|---|---|---|---|---|
| (1) | (f1 + bok1)/f1 | 0.582 | 0.565 | 0.578 | 0.694 | 0.468 | 0.649 | 0.590 |
| (2) | ft/f1 | 3.546 | 4.064 | 4.192 | 3.510 | 5.372 | 4.480 | 4.273 |
| (3) | f1/fw | 6.204 | 6.144 | 5.957 | 7.914 | 4.467 | 5.356 | 5.851 |
| (4) | vdLN | 55.530 | 60.080 | 58.540 | 55.530 | 58.540 | 60.080 | 58.540 |
| (5) | θCTLN − 0.0046 × vdLN | 0.578 | 0.588 | 0.583 | 0.578 | 0.583 | 0.588 | 0.583 |
| (6) | θCt1Pav − θCt1Nav | −0.003 | 0.025 | 0.029 | −0.005 | 0.029 | 0.022 | 0.009 |
| (7) | vd1Pav − vd1Nav | 31.194 | 35.942 | 36.455 | 30.242 | 36.455 | 36.437 | 32.370 |
| (8) | f1/fN1 | −8.056 | −7.476 | −7.082 | −7.135 | −6.457 | −6.763 | −6.842 |
| (9) | βN1W | −0.298 | −0.336 | −0.347 | −0.269 | −0.540 | −0.342 | −0.349 |
| (10) | f1/f12 | 1.547 | 1.401 | 1.370 | 1.311 | 2.094 | 1.381 | 1.302 |
| (11) | f1/L1 | 1.751 | 1.716 | 1.704 | 1.773 | 1.580 | 1.598 | 1.672 |
| (12) | bok1/L1 | −0.733 | −0.747 | −0.720 | −0.542 | −0.840 | −0.560 | −0.685 |
| | f1 | 155.311 | 153.686 | 149.028 | 142.454 | 167.530 | 133.910 | 146.273 |
| | fw | 25.034 | 25.014 | 25.017 | 18.000 | 37.500 | 25.000 | 25.000 |
| | ft | 550.751 | 624.510 | 624.681 | 499.997 | 899.982 | 599.970 | 624.986 |
| | bok1 | ·64.959 | −66.858 | −62.931 | −43.556 | −89.046 | −46.953 | −59.906 |
| | vdLN | S5.530 | 60.080 | 58.540 | 55.530 | 58.540 | 60.080 | 58.540 |
| | θCtLN | 0.833 | 0.865 | 0.853 | 0.833 | 0.853 | 0.865 | 0.853 |
| | θCt1Pav | 0.825 | 0.824 | 0.824 | 0.826 | 0.824 | 0.825 | 0.834 |
| | θCt1Nav | 0.828 | 0.799 | 0.795 | 0.831 | 0.795 | 0.804 | 0.825 |
| | vd1Pav | 85.664 | 84.512 | 84.512 | 85.312 | 84.512 | 85.664 | 86.310 |
| | vd1Nav | 54.470 | 48.570 | 48.057 | 55.070 | 48.057 | 49.227 | 53.940 |
| | fN1 | −19.278 | −20.558 | −21.043 | −19.966 | −25.947 | −19.800 | −21.378 |
| | βN1W | −0.298 | −0.336 | −0.347 | −0.269 | −0.540 | −0.342 | −0.349 |
| | f12 | 100.404 | 109.707 | 108.800 | 108.658 | 79.994 | 96.980 | 112.347 |
| | L1 | 88.679 | 89.550 | 87.446 | 80.347 | 106.044 | 83.777 | 87.504 |

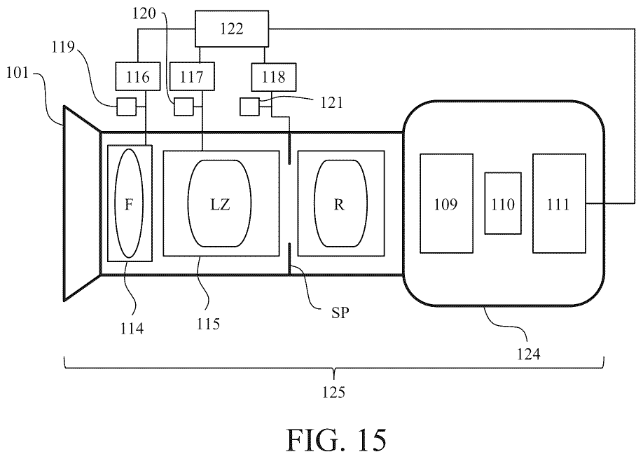

Next, an example configuration of an image pickup apparatus (broadcasting camera) 125 will be described with reference to FIG. 15. FIG. 15 is a configuration diagram of the main parts of the image pickup apparatus 125. In FIG. 15, reference numeral 101 denotes a zoom lens (imaging optical system) according to any one of Examples 1 to 7. Reference numeral 124 denotes a camera body (image pickup apparatus body). The zoom lens 101 is attachable to and detachable from the camera body 124. Reference numeral 125 denotes an image pickup apparatus configured by attaching the zoom lens 101 to the camera body 124.

The zoom lens 101 includes a first lens unit F, a magnification varying unit LZ, and a rear group R for imaging. The first lens unit F includes a lens unit for focusing. The magnification varying unit LZ includes a second lens unit that moves on the optical axis for magnification variation, and a third lens unit that moves on the optical axis to correct image plane variation associated with the magnification variation. SP represents an aperture stop. Reference numerals 114 and 115 denote drive mechanisms such as helicoids or cams that drive the first lens unit F and the magnification varying unit LZ in the optical axis direction. Reference numerals 116 to 118 denote motors (drive units) that electrically drive the drive mechanisms 114 and 115 and the aperture stop SP. Reference numerals 119 to 121 denote detectors such as encoders, potentiometers, or photosensors that detect the position on the optical axis of the first lens unit F or the magnification varying unit LZ, or the aperture diameter of the aperture stop SP.

Reference numeral 109 denotes a glass block that corresponds to an optical filter or color separating optical system within the camera body 124. Reference numeral 110 denotes an image sensor (photoelectric conversion element), such as a CCD sensor or CMOS sensor, which receives an object image formed by the zoom lens 101. Reference numerals 111 and 122 denote CPUs (control units) that control various drive functions of the camera body 124 and the zoom lens 101.

Thus, applying the zoom lens according to each example to a television camera, movie camera, or digital still camera can achieve an image pickup apparatus that has high optical performance in the wavelength range from visible light to NIR light, a reduced size and weight, and a high zoom ratio.

Each example can provide a zoom lens that has a reduced size, a high zoom ratio, and high optical performance, and an image pickup apparatus having the zoom lens.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-020608, filed on Feb. 12, 2025, and which is hereby incorporated by reference herein in its entirety.

What is claimed is:

1. A zoom lens comprising, in order from an object side to an image side:
a first lens unit with positive refractive power that does not move for magnification variation;
a movable lens unit including at least two lens units that move for magnification variation; and
a rear lens unit with positive refractive power that does not move for magnification variation,
wherein each distance between adjacent lens units changes for magnification variation, and
wherein the following inequalities are satisfied:
$$0.2 < ( f 1 + bok 1 ) / f 1 < 0.7$$
$$3. 50 < f t / f 1 < 8.$$
$$3. 00 < f 1 / fw < 20.00$$
$$35. 0 < vdLN < 65.$$
$$0.56 < θ CtLN - 0.0046 \times < vdLN < 0.6$$
where f1 is a focal length of the first lens unit, bok1 is a distance on an optical axis from a lens surface closest to an image plane in the first lens unit in an in-focus state at infinity to an image-side principal point of the first lens unit, ft is a focal length of the zoom lens at a telephoto end, fw is a focal length of the zoom lens at a wide-angle end, νdLN is an Abbe number for d-line of a negative lens included in the first lens unit, and θCtLN is a partial dispersion ratio for C-line and t-line of the negative lens.

2. The zoom lens according to claim 1, wherein the following inequality is satisfied:
$$- 0.040 < θ Ct 1 Pav - θ Ct 1 Nav < 0.06$$
where θCt1Pav is an average value of partial dispersion ratios for the C-line and the t-line of all positive lenses included in the first lens unit, and θCt1Nav is an average value of partial dispersion ratios for the C-line and the t-line of all negative lenses included in the first lens unit.

3. The zoom lenses according to claim 1, wherein the following inequality is satisfied:
$$10. < vd 1 Pav - vd 1 Nav < 60.$$
where νd1Pav is an average value of Abbe numbers for the d-line of all positive lenses included in the first lens unit, and νd1Nav is an average value of Abbe numbers for the d-line of all negative lenses included in the first lens unit.

4. The zoom lenses according to claim 1, wherein the following inequality is satisfied:
$$- 10.00 < f 1 / fN 1 < - 4.$$
where fN1 is a focal length of a first negative lens unit closest to an object in the movable lens unit.

5. The zoom lenses according to claim 1, wherein the following inequality is satisfied:
$$- 0.80 < βN 1 w < 0.00$$
where βN1w is a lateral magnification of a first negative lens unit closest to an object in the movable lens unit at the wide-angle end.

6. The zoom lens according to claim 1, wherein the first lens unit consists of a plurality of subunits in which each distance between adjacent subunits changes during focusing,
wherein the plurality of subunits include, in order from the object side to the image side, a first subunit that does not move for focusing, and a second subunit with positive refractive power that moves for focusing, and
wherein the following inequality is satisfied:
$$1. 00 < f 1 / f 12 < 3.$$
where f12 is a focal length of the second subunit.

7. The zoom lens according to claim 1, wherein the following inequality is satisfied:
$$1. < f 1 / L 1 < 2.50$$
where L1 is a distance on the optical axis from the lens surface closest to the object in the first lens unit to a lens surface closest to the image plane in the first lens unit in the in-focus state at infinity.

8. The zoom lenses according to claim 1, wherein the following inequality is satisfied:
$$- 1. < bok 1 / L 1 < - 0.4$$
where L1 is a distance on the optical axis from the lens surface closest to the object in the first lens unit to a lens surface closest to the image plane in the first lens unit in the in-focus state at infinity.

9. The zoom lenses according to claim 1, wherein the rear lens unit does not move for magnification variation.

10. The zoom lenses according to claim 1, wherein the first lens unit consists of a plurality of subunits in which each distance between adjacent subunits changes during focusing, and
wherein the plurality of subunits include, in order from the object side to the image side, a first subunit that does not move for focusing, a second subunit with positive refractive power that moves for focusing, and a third subunit with negative refractive power disposed adjacent to the second subunit on the image side.

11. The zoom lens according to claim 1, wherein the first lens unit includes a plurality of negative lenses.

12. The zoom lens according to claim 1, wherein the movable lens unit consists of, in order from the object side to the image side, a second lens unit and a third lens unit, and
wherein the rear lens unit consists of a fourth lens unit.

13. The zoom lens according to claim 1, wherein the movable lens unit consists of, in order from the object side to the image side, a second lens unit, a third lens unit, and a fourth lens unit, and
wherein the rear lens unit consists of a fifth lens unit.

14. The zoom lens according to claim 1, wherein the movable lens unit consists of, in order from the object side to the image side, a second lens unit, a third lens unit, a fourth lens unit, and a fifth lens unit, and
wherein the rear lens unit consists of a sixth lens unit.

15. An image pickup apparatus comprising:
a zoom lens; and
an image sensor,
wherein the zoom lens includes, in order from an object side to an image side:
a first lens unit with positive refractive power that does not move for magnification variation;
a movable lens unit including at least two lens units that move for magnification variation; and
a rear lens unit with positive refractive power that does not move for magnification variation,
wherein each distance between adjacent lens units changes for magnification variation, and
wherein the following inequalities are satisfied:
$$20 < ( f 1 + bok 1 ) / f 1 < 0.7$$
$$3. 50 < f t / f 1 < 8.$$
$$3. 00 < f 1 / fw < 20.00$$
$$35. 0 < vdLN < 65.$$
$$0.56 < θ CtLN - 0.0046 \times < vdLN < 0.6$$
where f1 is a focal length of the first lens unit, bok1 is a distance on an optical axis from a lens surface closest to an image plane of the first lens unit in an in-focus state at infinity to an image-side principal point of the first lens unit, ft is a focal length of the zoom lens at a telephoto end, fw is a focal length of the zoom lens at a wide-angle end, νdLN is an Abbe number for d-line of a negative lens included in the first lens unit, and θCtLN is a partial dispersion ratio for C-line and t-line of the negative lens.
